(19) United States
(12) Patent Application Publication
(10) Pub. No.: US 2019/0266218 A1
(43) Pub. Date: Aug. 29, 2019

(54) MATRIX COMPUTATION WITHIN A RECONFIGURABLE PROCESSOR FABRIC

(71) Applicant: Wave Computing, Inc., Campbell, CA (US)

(72) Inventors: David ST Clair Scott, Portland, OR (US); Thomas William St. John, San Jose, CA (US)

(21) Appl. No.: 16/286,891

(22) Filed: Feb. 27, 2019

Related U.S. Application Data
(60) Provisional application No. 62/636,309, filed on Feb. 28, 2018.
(60) Provisional application No. 62/637,614, filed on Mar. 2, 2018.
(60) Provisional application No. 62/650,758, filed on Mar. 30, 2018.
(60) Provisional application No. 62/650,425, filed on Mar. 30, 2018.
(60) Provisional application No. 62/679,046, filed on Jun. 1, 2018.
(60) Provisional application No. 62/679,172, filed on Jun. 1, 2018.
(60) Provisional application No. 62/692,993, filed on Jul. 2, 2018.
(60) Provisional application No. 62/694,984, filed on Jul. 7, 2018.
(60) Provisional application No. 62/773,486, filed on Nov. 30, 2018.
(60) Provisional application No. 62/800,432, filed on Feb. 2, 2019.
(60) Provisional application No. 62/802,307, filed on Feb. 7, 2019.

(51) Int. Cl. G06F 17/16; G06F 7/544; G06F 13/28

(52) U.S. Cl. CPC G06F 17/16; G06F 13/28; G06F 7/5443

(57) ABSTRACT

Techniques are disclosed for matrix computation within a reconfigurable fabric. A first matrix comprising a multiplier matrix and a second matrix comprising a multiplicand matrix are obtained for processing on a reconfigurable fabric. The first matrix and the second matrix are partitioned into submatrices. The first subset and the second subset are distributed to the plurality of processing elements. The processing elements for the first subset comprise a sequential path of adjacent processing elements within the reconfigurable fabric, where the sequential path forms a closed loop of processing elements starting and ending with a same first processing element. A partial matrix multiplication is performed at each of the subset of the plurality of processing elements. A result is output by recomposing results of the partial matrix multiplication at the subset of the plurality of processing elements that comprise the sequential path into a product matrix.

### RELATED APPLICATIONS

This application claims the benefit of U.S. provisional patent applications “Matrix Computation Within a Reconfigurable Processor Fabric” Ser. No. 62/636,309, filed Feb. 28, 2018, “Dynamic Reconfiguration Using Data Transfer Control” Ser. No. 62/637,614, filed Mar. 2, 2018, “Data Flow Graph Computation for Machine Learning” Ser. No. 62/650,758, filed Mar. 30, 2018, “Checkpointing Data Flow Graph Computation for Machine Learning” Ser. No. 62/650,425, filed Mar. 30, 2018, “Data Flow Graph Node Update for Machine Learning” Ser. No. 62/679,046, filed Jun. 1, 2018, “Dataflow Graph Node Parallel Update for Machine Learning” Ser. No. 62/679,172, filed Jun. 1, 2018, “Neural Network Output Layer for Machine Learning” Ser. No. 62/692,993, filed Jul. 2, 2018, “Data Flow Graph Computation Using Exceptions” Ser. No. 62/694,984, filed Jul. 7, 2018, “Reconfigurable Fabric Configuration Using Spatial and Temporal Routing” Ser. No. 62/773,486, filed Nov. 30, 2018, “Machine Learning for Voice Calls Using a Neural Network on a Reconfigurable Fabric” Ser. No. 62/800,432, filed Feb. 2, 2019, and “FIFO Filling Logic for Tensor Calculation” Ser. No. 62/802,307, filed Feb. 7, 2019.

Each of the foregoing applications is hereby incorporated by reference in its entirety.

### FIELD OF ART

This application relates generally to matrix manipulation and more particularly to matrix computation within a reconfigurable processor fabric.

### BACKGROUND

The emerging ability to collect vast amounts of data has increased the desires of researchers, governments, and business people alike to analyze that data. These immense datasets, frequently referred to as “big data”, defy analysis using traditional techniques and processors, principally because such analysis overwhelms the capabilities of the systems and techniques used to handle the data. Further to data analysis, data capture, storage, maintenance, access, transmission, visualization, etc., quickly exceed the capabilities of the traditional systems. Without a viable and scalable capacity to address the needs and uses of the data, the data would have little or no value. To make use of this data, innovative processing techniques, algorithms, heuristics, and so on, are demanded. Those who own the datasets or have access to the datasets are eager to analyze the data contained therein. The analysis is performed for a variety of purposes including business analysis; disease detection, tracking, and control; crime detection and prevention; meteorology; and complex science and engineering simulations, to name but a few. Advanced data analysis techniques such as predictive analytics are useful in extracting value from the datasets for business and other purposes. Further uses for the datasets include machine learning and deep learning in support of the data analysis.

The sharply increased quantity of data collected by entities such as businesses, governments, and researchers quickly overwhelm the capabilities of traditional designs and architectures of processors, integrated circuits, and other computing hardware. Data is collected by the entities to meet objectives such as computation, learning, prediction, surveillance, and tracking. Big data presents tremendous processing challenges because of the vast quantity of the collected data. While the data handling and processing challenges are significant, the various entities that collect the data are highly motivated to process the data and to analyze the results. Data processing is performed for many commercial, research, and security applications such as learning, marketing, and predicting, among many others. Further to the processing, the analysis, capture, maintenance, storage, transmission, visualization, and so on, of the data saturate the processing and handling capabilities of the traditional systems. Instead, new processing hardware such as advanced computer chips and architectures, and software such as algorithms, heuristics, functions, and so on, are required. The success of the new approaches can be measured using computational metrics and other metrics. The metrics can include high throughput such as high data throughput, fast data processing response time, low computational resources utilization, and so on.

One promising architecture for processing large data sets, performing complex computations, and other applications is based on reconfigurability. Reconfigurable computing draws on a combination of hardware and software techniques for its capabilities. A reconfigurable computing architecture can be “recoded” (reprogrammed) to perform a variety of computations, much like software, while implementing an underlying hardware architecture that is capable of high performance. A reconfigurable fabric is one such architecture used for reconfigurable computing. Reconfigurable fabrics can be arranged in a variety of topologies, where the topologies are coded for many applications that require high performance computing. Applications such as data processing, digital signal processing (DSP), neural networks such as convolutional neural networks (CNN) and deep neural networks (DNN), matrix computations, and so on, are successfully served by the capabilities of a reconfigurable fabric. The capabilities of the reconfigurable fabric fare particularly well when the data can include specific types of data, large quantities of unstructured data, matrices, tensors, and the like. The reconfigurable fabrics can be coded or scheduled to realize these and other processing techniques. Further, the reconfigurable fabric can be scheduled to represent a variety of computer architectures that can perform computations more efficiently.

### SUMMARY

Reconfigurable computing includes architectures that incorporate a combination of circuit techniques and coding techniques. The hardware within the reconfigurable architectures is efficiently designed and achieves high performance when compared to the performance of general purpose hardware. Further, these reconfigurable architectures can be adapted or “recoded” based on techniques similar to those used to modify software. That is, the reconfigurable architecture can be adapted by changing the code used to configure the elements of the architecture. A reconfigurable computing architecture can be implemented using a reconfigurable processor fabric. The reconfigurable processor fabric can include computational or processor elements, storage elements, switching elements for data transfer, and so on. The reconfigurable fabrics are coded to implement a variety of processing topologies, many of which require high performance computing. The many applications that can be implemented can include matrix computation architectures. The reconfigurable fabric can be configured by coding or scheduling the reconfigurable fabric to execute matrix computation techniques. The scheduling of the reconfigurable fabric can support a variety of computer architectures such as those which perform matrix computations with high efficiency. The scheduling of the reconfigurable fabric can be changed based on a data flow graph.

Matrix computation is performed within a reconfigurable processor fabric. The reconfigurable fabric includes a variety of “elements” such as processing elements, switching elements, storage elements, communications capabilities, and so on. Embodiments include a processor-implemented method for matrix manipulation comprising: obtaining, for processing on a reconfigurable fabric comprised of a plurality of processing elements, a first matrix, wherein the first matrix comprises a multiplier matrix; obtaining, for processing on the reconfigurable fabric, a second matrix, wherein the second matrix comprises a multiplicand matrix; partitioning the first matrix and the second matrix, respectively, into a first set of submatrices and a second set of submatrices; distributing the first set of submatrices around a subset of the plurality of processing elements, wherein the subset of the plurality of processing elements comprises a sequential path of adjacent processing elements within the reconfigurable fabric, wherein the sequential path forms a closed loop of processing elements starting and ending with a same first processing element; distributing the second set of submatrices around the subset of the plurality of processing elements; performing a partial matrix multiplication at each of the subset of the plurality of processing elements that comprise a sequential path, wherein a portion of the second set of submatrices is sequentially rotated through the subset of the plurality of processing elements; and outputting a result by recomposing results of the partial matrix multiplication at the subset of the plurality of processing elements that comprises the sequential path into a product matrix. In embodiments, the performing the partial matrix multiplication is accomplished using the first set of submatrices and the portion of the second set of submatrices. Some embodiments include performing a second partial matrix multiplication at each of the subset of the plurality of processing elements.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for matrix computation within a reconfigurable processor fabric.

FIG. 2 is a flow diagram for matrix partitioning.

FIG. 3A shows a rotation path through a reconfigurable processor fabric.

FIG. 3B shows rotation of a portion of the submatrices.

FIG. 4 illustrates sequential partial matrix multiplication using multiply-accumulate.

FIG. 5A shows orientation of a first partial product.

FIG. 5B shows orientation of a second partial product.

FIG. 5C shows orientation of a third partial product.

FIG. 5D shows orientation of a fourth partial product.

FIG. 6 shows a cluster for coarse-grained reconfigurable processing.

FIG. 7 shows a block diagram of a circular buffer.

FIG. 8 illustrates a circular buffer and processing elements.

FIG. 9 shows a deep learning block diagram.

FIG. 10 is a system diagram for matrix computation within a reconfigurable processor fabric.

### DETAILED DESCRIPTION

Techniques are disclosed for matrix computation within a reconfigurable processor fabric. Matrix multiplication, also referred to as a matrix product or “dot product”, is an operation that combines two matrices, such as A and B, to produce one matrix. C. This matrix production, also called a binary operation since two matrices are combined into one matrix, has many applications in fields such as engineering, applied physics, applied mathematics, and so on. The matrices A, B, or input matrices, can have various dimensions. For example, matrix A can be an n×m matrix and matrix B can be an m×p matrix. The matrix product AB can be a matrix with dimensions n×p. The matrix product can be calculated by multiplying m entries across a given row of A by the m entries down a given column of B. The resulting partial products (each Aₘ*Bₘ) can be tallied or summed to produce a given value of an entry in AB. The matrix product resulting from a matrix computation can be performed within the reconfigurable fabric.

A reconfigurable fabric can include one or more types of elements, such as processing elements, storage elements, switching elements, and so on. An element can be configured to perform a variety of architectural and computational tasks based on the type of element. The reconfigurable fabric can include quads or workgroups of elements, where the workgroups can include processing elements, shared storage elements, switching elements, circular buffers for control, communications paths, and the like. An element or subset of elements within the reconfigurable fabric can be controlled by providing code to one or more circular buffers. Code can also be provided to a plurality of elements within the reconfigurable fabric so that the reconfigurable fabric can perform various computational tasks such as matrix computations. The various elements of the reconfigurable fabric can be controlled using one or more rotating circular buffers. Functions, algorithms, instructions, codes, etc., can be loaded into a given circular buffer. The one or more circular buffers can be of the same length or of differing lengths. The rotation of the circular buffer ensures that the same series of steps or instructions is repeated as required by the processing tasks assigned to a processing element of the reconfigurable fabric. The one or more rotating circular buffers can be statically scheduled.

Matrix computation is performed within a reconfigurable processor fabric. A first matrix is obtained for processing on a reconfigurable fabric comprised of a plurality of processing elements. The first matrix comprises a multiplier matrix. A second matrix is obtained for processing on the reconfigurable fabric. The first matrix and the second matrix are partitioned, respectively, into a first set of submatrices and a second set of submatrices. The submatrices can be square matrices, rectangular matrices, etc. The dimensions of the submatrices can be based on a power of 2. The power of 2 can provide a 2×2 submatrix. The first set of submatrices is distributed around a subset of the plurality of processing elements. The subset of the plurality of processing elements comprises a sequential path of adjacent processing elements within the reconfigurable fabric. The sequential path forms a closed loop of processing elements, starting and ending with a same first processing element. The second set of submatrices is distributed around the subset of the plurality of processing elements. A partial matrix multiplication is performed at each of the subset of the plurality of processing elements that comprise a sequential path. A portion of the second set of submatrices is sequentially rotated through the subset of the plurality of processing elements. A result is output by recomposing results of the partial matrix multiplication at the subset of the plurality of processing elements that comprises the sequential path into a product matrix.

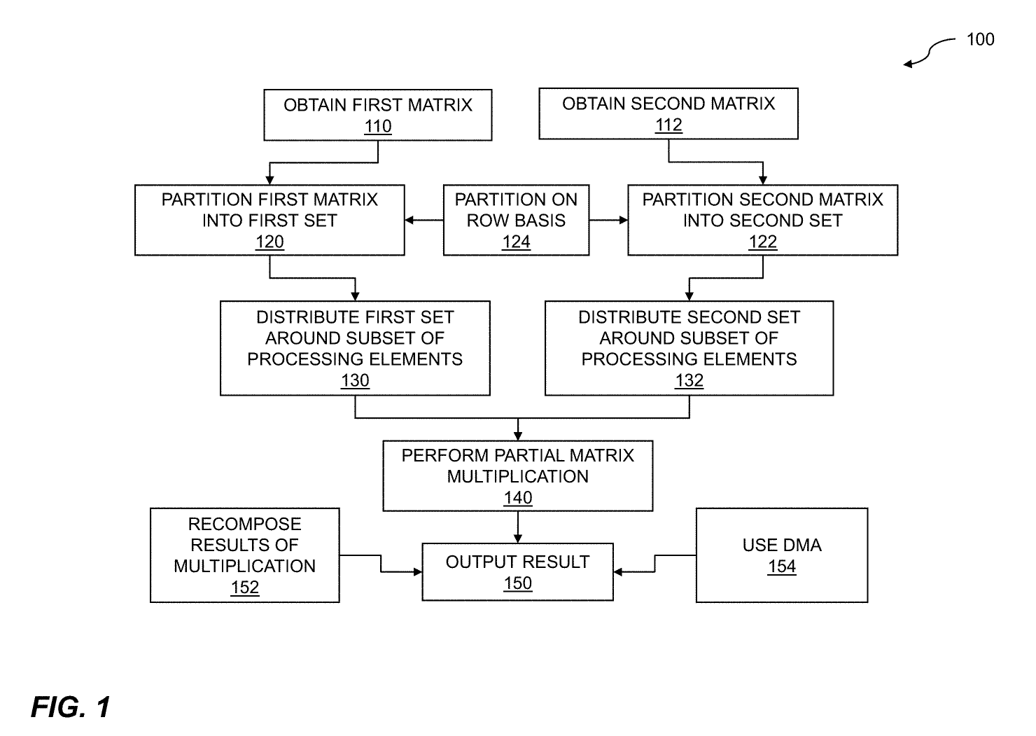

FIG. 1 is a flow diagram for matrix computation within a reconfigurable processor fabric. The flow 100 includes obtaining, for processing on a reconfigurable fabric comprised of a plurality of processing elements, a first matrix 110. The first matrix can comprise a multiplier matrix. The first matrix can be a square matrix, a rectangular matrix, and so on. The first matrix can include an even number of rows, an odd number of rows, an even number of columns, or an odd number of columns. The flow 100 includes obtaining, for processing on the reconfigurable fabric, a second matrix 112. The second matrix comprises a multiplicand matrix. As with the first matrix, the second matrix can be a square matrix, a rectangular matrix, etc. In embodiments, the first matrix and the second matrix each comprise multidimensional tensor matrices. The second matrix can include even or odd numbers of rows or columns. The flow 100 includes partitioning the first matrix and the second matrix, respectively, into a first set 120 of submatrices and a second set 122 of submatrices. The partitioning of the first matrix and the partitioning of the second matrix can include partitioning based on rows or columns. In embodiments, the partitioning can be done on a row basis 124. The partitioning done on a row basis can be applied to the first matrix or to the second matrix. In embodiments, the partitioning the first matrix can separate the first matrix into pairs of columns. The partitioning can include groupings other than two columns such as three columns or other numbers of columns. The partitioning the first matrix can separate the first matrix into pairs of rows. As with the first matrix, the second matrix can be partitioned. In embodiments, the partitioning the second matrix can separate the second matrix into pairs of columns. The second matrix can be partitioned based on other numbers of columns. The partitioning the second matrix can separate the second matrix into pairs of rows.

The flow 100 includes distributing the first set of submatrices around a subset of the plurality of processing elements 130. The subset of the processing elements can include quads of processing elements. The subset of the plurality of processing elements includes a sequential path of adjacent processing elements within the reconfigurable fabric. The adjacent processing elements can include one or more quads of processing elements. The sequential path within the processing elements forms a closed loop of processing elements, starting and ending with a same first processing element. The sequential path within the processing elements can be used to rotate data such as matrices, submatrices, tensors, multidimensional tensors, agents, etc., among processors of the closed loop of processors. The flow 100 includes distributing the second set of submatrices around the subset 132 of the plurality of processing elements. The plurality of processing elements to which the second set of submatrices can be distributed can be adjacent to the closed loop of processing elements. The plurality of processing elements can be in communication with the closed loop of processing elements. In embodiments, the distributing of the first set of submatrices and the distributing of the second set of submatrices can be accomplished using direct memory access (DMA) operations from another memory into the subset of the plurality of processing elements. The one or more DMA operations can be performed within the reconfigurable processor fabric, between the reconfigurable processor fabric and a memory located beyond the reconfigurable processor fabric, and so on.

The flow 100 includes performing a partial matrix multiplication 140 at each subset of the plurality of processing elements that comprise a sequential path. The partial matrix multiplication can include a multiply-accumulate function, where a running sum or accumulation of the partial matrix multiplications can be held. A portion of the second set of submatrices can be sequentially rotated through the subset of the plurality of processing elements. The sequential rotation of the second set of submatrices supports the computation of the plurality of partial matrix multiplications. In embodiments, the performing the partial matrix multiplication can be accomplished using the first set of submatrices and the portion of the second set of submatrices. When all partial matrix multiplications have been performed and a rotation is executed, the flow can further include performing a second partial matrix multiplication at each of the subset of the plurality of processing elements. The steps of partial matrix multiplication, accumulation, and rotation, can continue for as many times as there are processors in the closed loop of processing elements. In embodiments, the second partial matrix multiplication can be accomplished using the first set of submatrices and a second portion of the second set of submatrices. When more than two portions of the second set of submatrices exist, other partial matrix multiplications can be performed. In embodiments, the second portion of the second set of submatrices can be sequentially rotated through the subset of the plurality of processing elements.

The processing elements can each complete their multiply operation in one tick cycle. In some cases, this tick cycle can be referred to as a sub-tick. A tick cycle can include execution of one or more instructions that can be stored in a circular buffer, where the circular buffer can be used to control one or more processing elements. A tick cycle can include a complete rotation of the circular buffer. A complete rotation of the circular buffer can include executing all of the instructions stored in the circular buffer. In embodiments, the second set of submatrices can be sequentially rotated at the end of a tick cycle. The multiplication of the matrices, submatrices, and so on, can be controlled using various techniques. In embodiments, the matrix multiplication can be part of machine learning. The machine learning can be based on supervised learning, unsupervised or autonomous learning, semi-autonomous learning, and so on. In embodiments, the matrix multiplication can use results of the machine learning. The results of the machine learning can be used to partition matrices into submatrices, to distribute matrices to subsets or processors such as quads of processors within the reconfigurable fabric, to control rotation of submatrices around the closed loop of processing elements, etc. The results of the machine learning can include layers and weights within a neural network, where the neural network can control the partial matrix multiplications, matrix multiplications, and the like. In embodiments, the neural network can include a convolutional neural network, a deep neural network, and so on.

The flow 100 includes outputting a result 150 by recomposing results of the partial matrix multiplication 152 at the subset of the plurality of processing elements that includes the sequential path, into a product matrix. The recomposing can include adding partial products, forming an output or product matrix based on the partial products, and so on. In embodiments, the recomposing can be performed after the partial matrix multiplication and the second partial matrix multiplication. The recomposing can be performed using the first or second subset of processing elements, on another subset of processing elements, beyond the reconfigurable processor fabric, etc. In embodiments, the recomposing can be accomplished using direct memory access (DMA) operations 154 from the subset of the plurality of processing elements into another memory. The other memory can be coupled to the reconfigurable processor fabric, located beyond the reconfigurable processor fabric, etc. Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

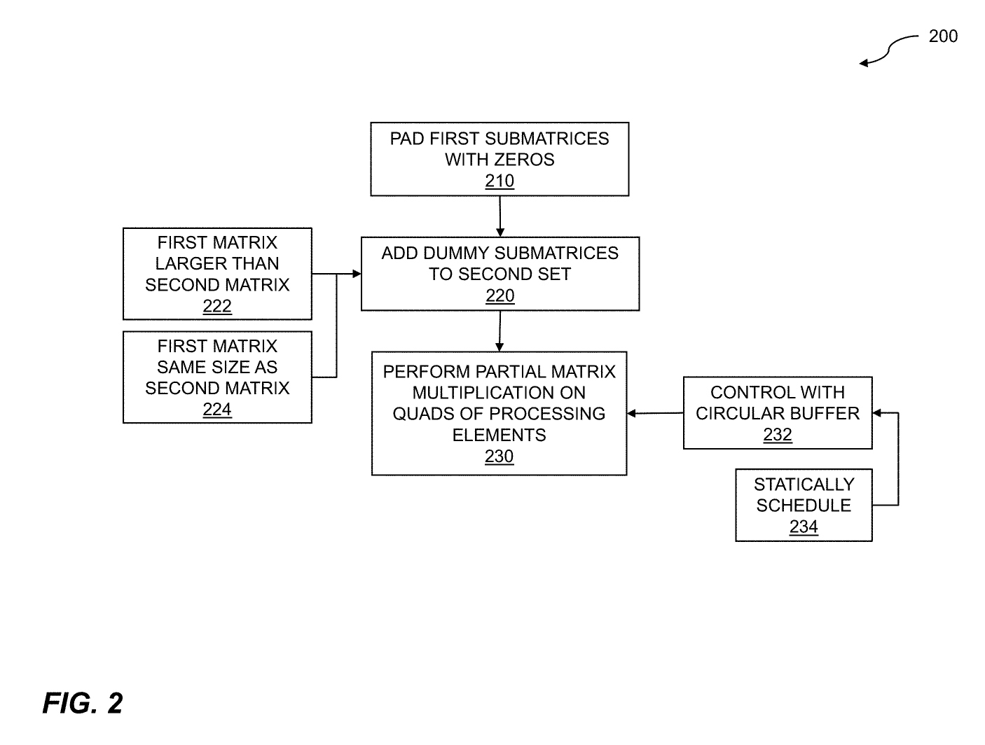

FIG. 2 is a flow diagram for matrix partitioning. Matrix multiplication can be performed within a reconfigurable processor fabric. The matrices that are multiplied, a multiplier matrix, and a multiplicand matrix, can be partitioned into submatrices, where the submatrices can be distributed to processing elements within the reconfigurable fabric. In embodiments, the submatrices can be multiplied in parallel by the processing elements. The partial products, or partial matrix multiplications, that are generated by the multiplications of the submatrices, can be accumulated by a multiply-accumulate component. A result can be determined by recomposing results of partial matrix multiplications into a product matrix. The product matrix can be output.

As discussed elsewhere, the partitioning of the multiplier matrix or the multiplicand matrix can separate a matrix into numbers of columns or numbers of rows. In embodiments, the partitioning the first matrix can separate the first matrix into pairs of rows. Similarly, in other embodiments, the partitioning the second matrix can separate the second matrix into pairs of columns. The pairs of rows of the first matrix can be multiplied by the pairs of columns of the second matrix directly using processors within the reconfigurable processor fabric. In other embodiments, the partitioning the second matrix can separate the second matrix into pairs of rows. The pairs of rows of the first matrix can be multiplied by the pairs of columns of the second matrix by further partitioning the rows or columns. The partitioning of the first matrix or the second matrix can form sets of submatrices of the first matrix or sets of submatrices of the second matrix. In embodiments, each submatrix of the first set of submatrices is a square matrix with smaller dimensions than the first matrix. Each square submatrix includes equal numbers of rows and columns. For computational efficiency, in embodiments, the square matrix dimension of the first set of submatrices can a power of 2. The square matrix dimension of the first set of submatrices can include other values such as 3, 5, etc. In embodiments, the power of 2 can provide a 2×2 submatrix. The power of 2 can provide a 4×4, 8×8, or other square submatrices based on other powers of 2. In embodiments, each submatrix of the second set of submatrices can be a square matrix with smaller dimensions than the second matrix, where each submatrix includes equal numbers of rows and columns. As with the first set of submatrices, the square matrix dimension of the second set of submatrices can be a power of 2. The square matrix dimension of the second set of submatrices can have values different from a power of 2. In embodiments, the power of 2 can provide a 2×2 submatrix. The power of 2 could also provide 4×4 submatrix, an 8×8 submatrix, and so on.

The first matrix or the second matrix may include an odd number of rows or columns. An odd number of rows or columns indicates that the first matrix or the second matrix cannot be partitioned evenly into pairs of rows or columns. This problem can be circumvented by padding submatrices or adding dummy matrices. The flow 200 includes padding one or more of the first submatrices with zeros 210 when the first matrix partitions unevenly into submatrices around a ring of processing elements. The processing elements, which include processing elements within the reconfigurable processor fabric, can form a sequential path, loop, or ring of adjacent processing elements, as described elsewhere. The submatrices padded with zeros can be distributed around the ring of processing elements, thus filling the ring. The flow 200 includes adding one or more dummy submatrices to the second set 220 of submatrices when the number of second-set submatrices is less than the number of first-set submatrices. The number of second-set submatrices can be less than the number of first-subset submatrices when the first matrix is larger 222 than the second matrix. In other embodiments, the first matrix can be the same size as the second matrix 224. Whether or not the first matrix is larger than or the same size as the second matrix, padding of the first submatrices with zeros, or adding dummy submatrices to the second set, may still need to be performed.

The flow 200 includes performing a partial matrix multiplication at each of the subset of the plurality of processing elements that comprise a sequential path, where the plurality of processing elements is comprised of quads 230 of processing elements. The quads of processing elements can include other elements such as storage elements, switching elements, direct memory access (DMA), and so on. The quads of processing elements can form a closed loop of processing elements starting and ending with the same first processing element. In embodiments, the processing elements can be controlled by a rotating circular buffer 232. The rotating circular buffer can include instructions, functions, heuristics, etc., that can be used to perform matrix multiplications and other operations. In embodiments, the circular buffer can be statically scheduled 234. Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors.

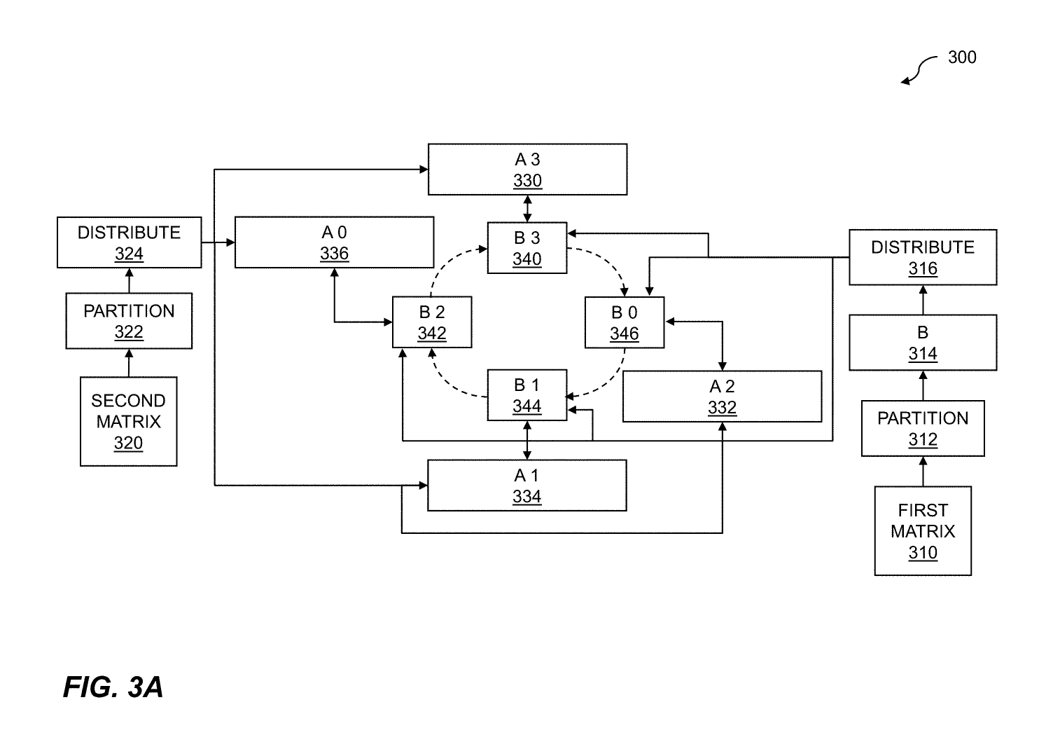

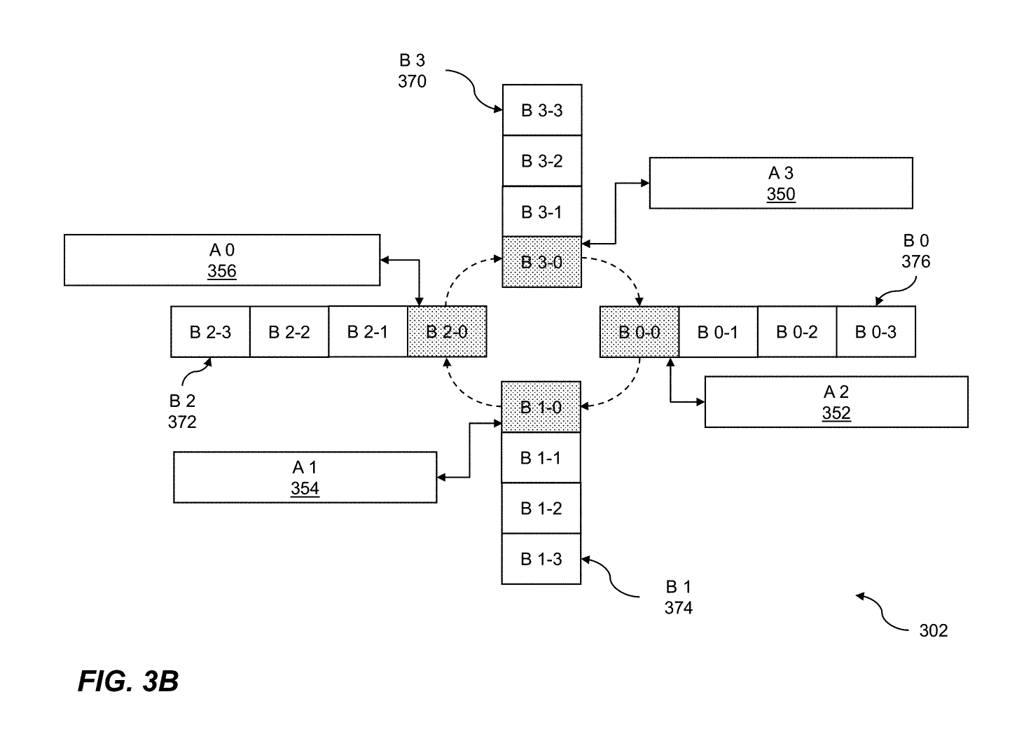

FIG. 3A shows a rotation path through a reconfigurable processor fabric. Matrix computation, such as matrix multiplication, can be performed within a reconfigurable processor fabric. Matrix multiplication can multiply two or more matrices to calculate a matrix product. The matrix product can be represented by a third matrix. The matrix product can be computed by:

(AB)ᵢⱼ=Σₖ₌₁^{m}AᵢₖBₖⱼ

A first matrix for processing on a reconfigurable fabric is obtained. The first matrix can be a multiplier matrix. A second matrix can be obtained for processing on the reconfigurable fabric. The second matrix can be a multiplicand matrix. The first matrix and the second matrix, respectively, can be partitioned into a first set of submatrices and a second set of submatrices. The first set of submatrices can be distributed around a subset of the processing elements, where the subset of processing elements includes a sequential path of adjacent processing elements within the reconfigurable fabric. The sequential path forms a closed loop of processing elements starting and ending with a same first processing element. The second set of submatrices can be distributed around the subset of the plurality of processing elements. A partial matrix multiplication is performed at each of the subset of processing elements that includes a sequential path. A portion of the second set of submatrices can be sequentially rotated through the subset of processing elements. A result can be output by recomposing, into a product matrix, results of the partial matrix multiplication at the subset of processing elements that includes the sequential path.

A rotating path through a reconfigurable fabric is shown 300. A first matrix 310 can be obtained, where the first matrix can be a multiplier matrix. The first matrix can be partitioned 312 into the set of submatrices B 314. The first matrix can be partitioned into clusters and can be distributed 316 to a sequential path of adjacent processing elements. The sequential path of adjacent processing elements can include B3 340, B2 342, B1 344, B0 346, and so on. The number of adjacent processing elements in a closed loop of adjacent processing elements can be based on the number of clusters that result from partitioning the first matrix. A second matrix 320 can be obtained, where the second matrix can be a multiplicand matrix. The second matrix can be partitioned 322 into clusters, and the clusters can be distributed 324 around the subset of processing elements. The processing elements can include A3 330, A2 332, A1 334, AO 336, and so on. Once the segments from the matrices have been distributed to processing elements of the reconfigurable fabric, a matrix multiplication can be performed. The matrix multiplication can result in a partial product. One or more partial products can be collected using a multiply-accumulate technique. The matrix clusters associated with the closed loop of processing elements can be rotated around the loop. A rotation can include transferring B3 from 340 to 346, B0 from 346 to 344, B1 from 344 to 342, B2 from 342 to 340, and so on. Another set of matrix multiplications can be executed, and the resulting partial products can be accumulated. The steps of multiplying, accumulating, and rotating can be repeated based on the number of processing elements within the closed loop of processing elements.

FIG. 3B shows rotating a portion of the submatrices. A set of submatrices can result from partitioning one or more matrices into one or more submatrices. The submatrices can simplify, improve, or otherwise support matrix computation within a reconfigurable fabric. A portion of rotating submatrices is shown 302. Two submatrices, submatrix A and submatrix B are included. The submatrices such as submatrices A and B can be distributed onto one or more subsets of processing elements. One subset of processing elements can form a closed loop, where the closed loop begins and ends with the same processing element. Another subset of processing elements can include processing elements located around the closed loop of processing elements. Partial matrix multiplications can be performed between the submatrices. A result can be recomposed from the partial matrix multiplications into a product matrix, and the product matrix can be output.

Submatrices B3 370, B2 372, B1 374, and B0 376 of matrix B can be distributed around a closed loop of processing elements. Each submatrix B3, B2, B1, and B0 can include one or more segments. B3 can include segments B3-3, B3-2, B3-1, and B3-0; B2 can include segments B2-3, B2-2, B2-1, and B2-0; B1 can include segments B1-3, B1-2, B1-1, and B1-0; and B0 can include segments B0-3, B0-2, B0-1, and B0-0. While four segments are shown, other numbers of segments can be included. Submatrices A3 350, A2 352, A1 354, and AO 356 can be distributed to processing elements of the reconfigurable processor fabric. The A matrices can include segments (not shown). A set of partial matrix multiplications between A3 and B3-0; A2 and B0-0; A1 and B1-0; and AO and B2-0 can be calculated. The B segments can rotate to the next position in the closed loop of processing elements. Another set of partial matrix multiplications can be performed, and the partial products resulting from the partial matrix multiplications can be accumulated with the prior partial matrix multiplications.

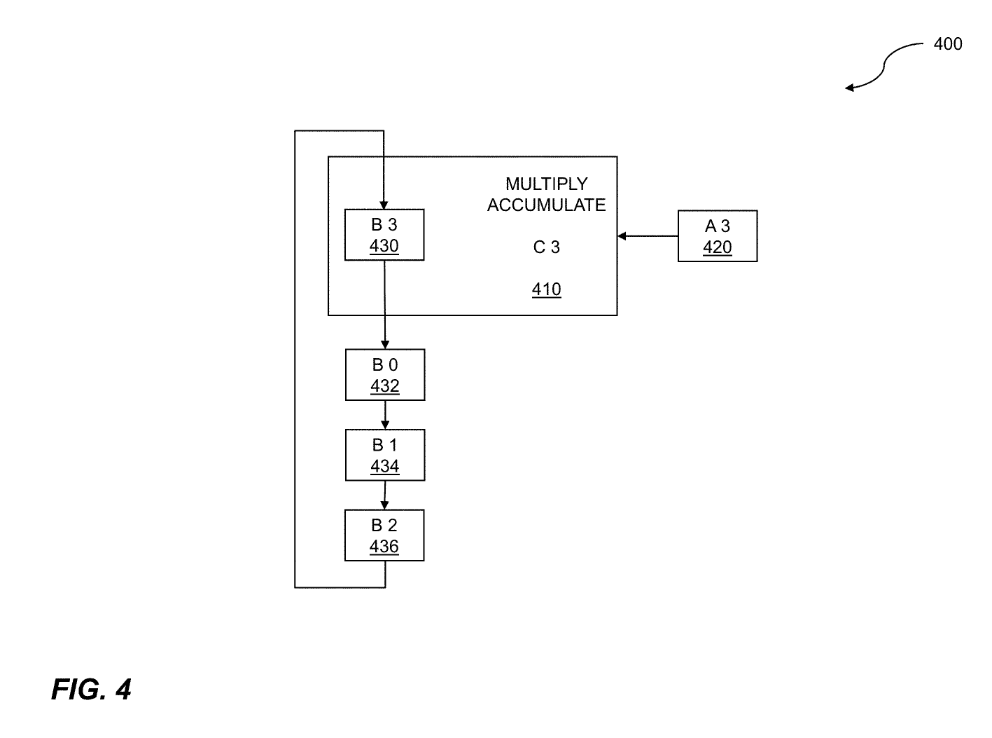

FIG. 4 illustrates sequential partial matrix multiplication using multiply-accumulate computations. Multiply-accumulate computations, such as C=C+A*B, can support matrix computation within a reconfigurable processor fabric. A first matrix, a multiplier matrix, and a second matrix, a multiplicand matrix, can be obtained for processing by one or more processing elements within the reconfigurable fabric. The first matrix and the second matrix, respectively, can be partitioned into a first set of submatrices and a second set of submatrices. The first set of submatrices can be distributed around a subset of the processing elements. The subset of the plurality of processing elements can include a sequential path of adjacent processing elements within the reconfigurable fabric. The sequential path forms a closed loop of processing elements starting and ending with a same first processing element. The second set of submatrices can be distributed around the subset of the plurality of processing elements. A partial matrix multiplication, which can include a multiply-accumulate operation, can be performed at each of the processing elements that form a sequential path. A portion of the second set of submatrices can be sequentially rotated through the subset of processing elements. A result can be output by recomposing results of the partial matrix multiplication into a product matrix.

An illustration of sequential partial matrix multiplication using a multiply-accumulate calculation is shown 400. A multiply-accumulate component 410 can receive as inputs two or more clusters of submatrices to compute a partial product C 3. The input clusters can include an input cluster A 3 420, an input cluster B 3 430, and so on. The input cluster B 3 430 can be stored within memory associated with the multiply-accumulate component 410. The B input can include multiple clusters, such as cluster B 3 430, B 0 432, B 1 434, B 2 436, and so on. A multiply-accumulate component can be associated with memory containing each of the B 0 432, B 1 434, and B 2 436 inputs. While four B clusters are shown, other numbers of B clusters can be included depending on the dimensions of the B matrix. The B submatrices and the A submatrix can result from partitioning the first matrix and partitioning the second matrix. To compute the partial product C 3, each cluster from the B submatrix is multiplied with A 3 and added to the accumulated partial product C 3. Thus, to perform the computation, A 3 is multiplied by B 3 and the partial product is added to C 3. B can be rotated so that B 2 is available for multiplication with A 3. B 2 is multiplied with A 3 and the partial product is added to C 3. B can be rotated, making B 1 available. B 1 is multiplied with A 3 and the partial product is added to C 3. B can be rotated again, making B 0 available. B 0 can be multiplied with A 3 and the partial product added to C 3. The steps of rotating, multiplying, and accumulating can be repeated for as many times as there are clusters in B.

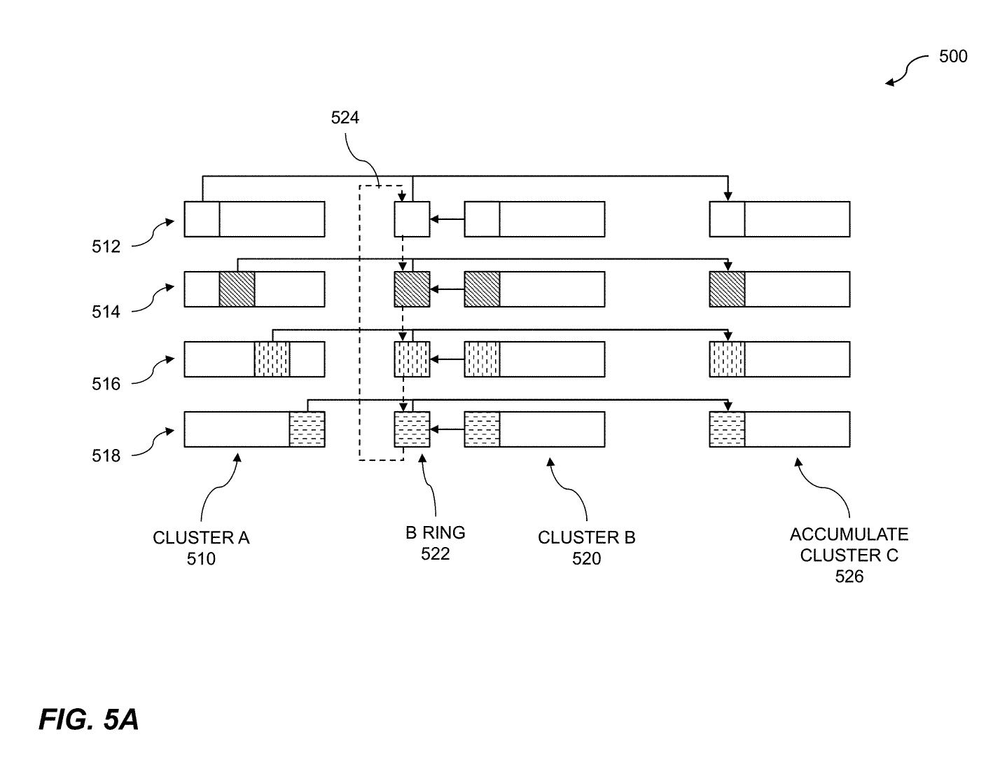

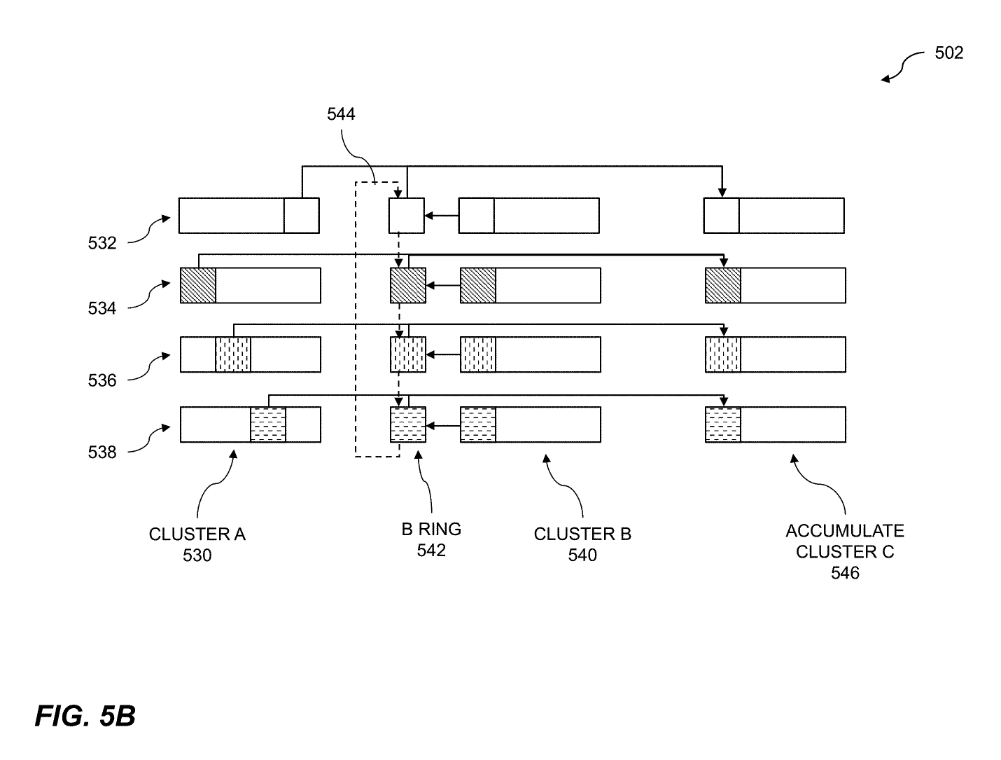

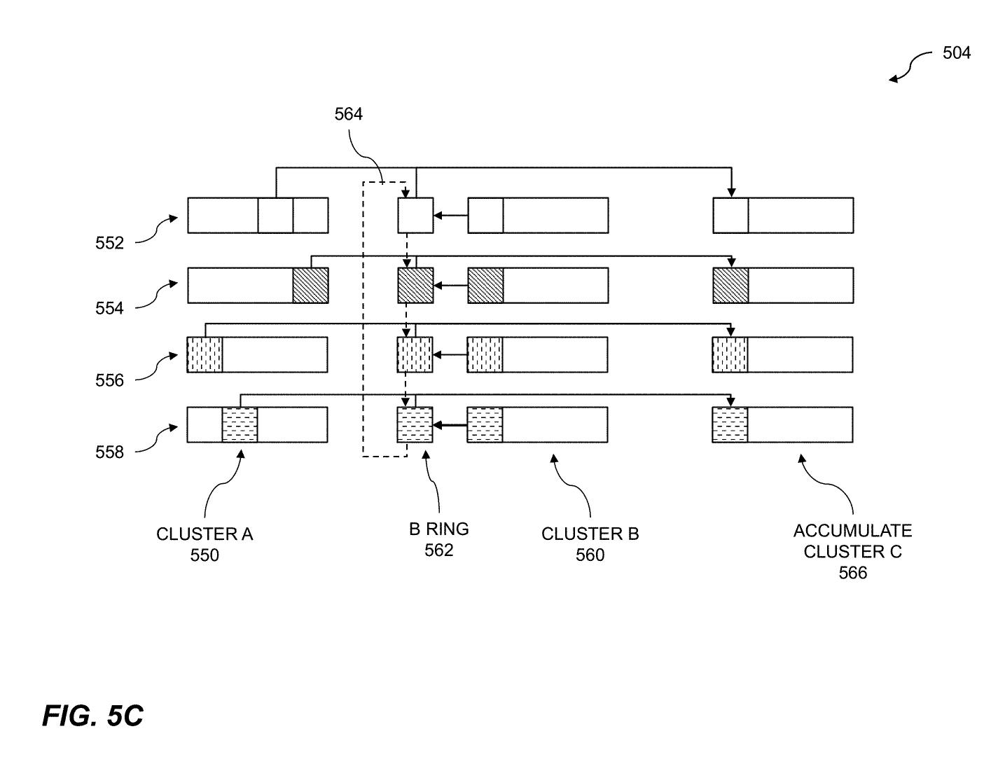

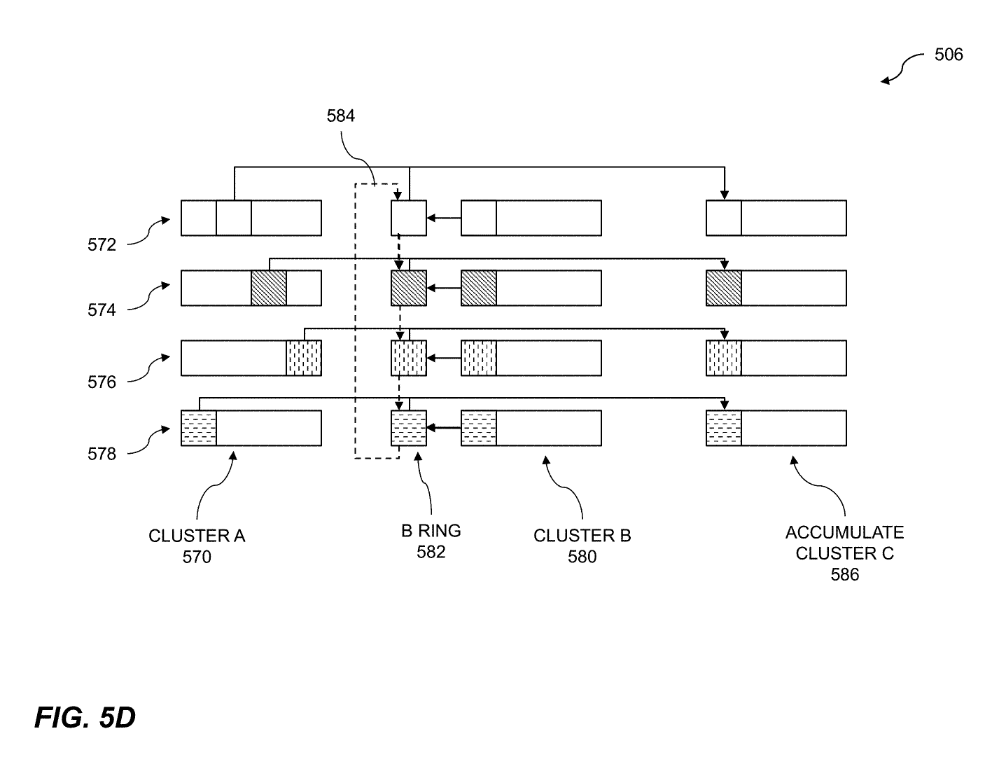

FIG. 5A shows orientation of a first partial product. Partial products 500 can be calculated for matrix computation within a reconfigurable processor fabric. The partial products can result from performing partial matrix multiplication for submatrices that result from partitioning a first matrix, here called the multiplier, and partitioning a second matrix, here called the multiplicand. In embodiments, the partitioning the first matrix can separate the first matrix into pairs of rows. The first matrix may also be partitioned into pairs of columns. In further embodiments, the partitioning the second matrix can separate the second matrix into pairs of columns. The second matrix may also be partitioned in pairs of rows. The submatrices can be square matrices. If the first matrix does not partition evenly into pairs of rows or pairs of columns, the submatrices can be padded with zeros. The partial matrix multiplication can include a multiply-accumulate function such as C=C+A*B.

A first set of partial products is shown 500. To perform the operations of multiplying A and B, and accumulating partial products in C, the matrices A, B, and C can be partitioned into rows 512, 514, 516, and 518. The matrix computations can be performed by multiplying segments or clusters of each row and accumulating the partial products. The matrix computations can include multiplying cluster A 510 by cluster B 520 and accumulating the partial products in accumulate cluster C 526. Since clusters of B are multiplied by each cluster of A, the clusters from each row of B 520 can be loaded into a B ring 522, or “Ferris wheel”. While A remains in place, the B ring rotates 524 so that each B cluster in the B ring can be multiplied by each cluster in A. Each of the partial products resulting from the multiplications of an A cluster by each cluster in the B ring can be accumulated in accumulate cluster C. Since the rows 512, 514, 516, and 518 represent different rows of matrices A, B, and C, the multiply-accumulate operations can be performed in parallel.

FIG. 5B shows orientation of a second partial product. Second partial products 502 can be calculated for matrix computation within a reconfigurable processor fabric. A second set of partial product computations is shown, where a second set of clusters from A is multiplied by a cluster of B. To perform the operations of multiplying A and B, and accumulating partial products in C, the matrices A, B, and C can be partitioned into rows 532, 534, 536, and 538. The matrix computations can be performed by multiplying a second set of segments or clusters of each row and accumulating the partial products. The matrix computations can include multiplying the second cluster A 530 by cluster B 540 and accumulating the partial products in accumulate cluster C 546. Since clusters of B are multiplied by each second cluster of A, the clusters from each row of B 540 can be loaded into a B ring 542, or “Ferris wheel”. While A remains in place, the B ring rotates 544 so that each B cluster in the B ring can be multiplied by each second cluster in A. Each of the partial products resulting from the multiplications of a second A cluster by each cluster in the B ring can be accumulated in accumulate cluster C. As stated above, since the rows 532, 534, 536, and 538 can represent different rows of matrices A, B, and C, the multiply-accumulate operations can be performed in parallel.

FIG. 5C shows orientation of a third partial product. A third set of partial products 504 can be calculated for matrix computation within a reconfigurable processor fabric. The third set of partial product computations is shown, where a third set of clusters from A is multiplied by a cluster of B. As previously discussed, to perform the operations of multiplying A and B, and accumulating partial products in C, the matrices A, B, and C can be partitioned into rows 552, 554, 556, and 558. The set of matrix computations can be performed by multiplying the third set of segments or clusters of each row of A with clusters of B and accumulating the partial products in C. The matrix computations can include multiplying the third cluster A 550 by cluster B 560 and accumulating the partial products in accumulate cluster C 566. Recalling that clusters of B are multiplied by each third cluster of A, the clusters from each row of B 560 can be loaded into a B ring 562 or “Ferris wheel”. While A remains in place, the B ring rotates 564 so that each B cluster in the B ring can be multiplied by each third cluster in A. Each of the partial products resulting from the multiplications of a third A cluster by each cluster in the B ring can be accumulated in accumulate cluster C. As stated above, since the rows 552, 554, 556, and 556 can represent different rows of matrices A, B, and C, the multiply-accumulate operations can be performed in parallel.

FIG. 5D shows orientation of a fourth partial product. Similar to the previous other partial products described above, a fourth set of partial products 506 can be calculated for matrix computation within a reconfigurable processor fabric. The fourth set of partial product computations is shown, where a fourth set of clusters from A is multiplied by a cluster of B. To perform the operations of multiplying A and B, and accumulating partial products in C, the matrices A, B, and C can be partitioned into rows. The rows can include rows 572, 574, 576, and 578. The set of matrix computations for the fourth partial product can be performed by multiplying the fourth set of clusters of each row of A with clusters of B and accumulating the partial products in C. The matrix computations can include multiplying the fourth cluster A 570 by cluster B 580 and accumulating the partial products from the fourth partial products in accumulate cluster C 586. Noting once again that the clusters of B are multiplied by each fourth cluster of A, the clusters from each row of B 580 can be loaded into a B ring 582 or “Ferris wheel”. While A remains in place, the B ring rotates 584 so that each B cluster in the B ring can be multiplied by each fourth cluster in A. Each of the partial products resulting from the multiplications of a fourth A cluster by each cluster in the B ring can be accumulated in accumulate cluster C. As with the previous example calculations of partial products, since the rows 572, 574, 576, and 578 can represent different rows of matrices A, B, and C, the multiply-accumulate operations can be performed in parallel. While four partial products have been shown, other numbers of partial products can be calculated. Having computed the partial products for cluster A and the first set of clusters B, B can be rotated, and a second set of B clusters can be loaded into the B ring. The accumulate cluster C may also be rotated. The steps for computing the partial products can be repeated as often as necessary to accommodate the numbers of clusters in A and the numbers of clusters in B.

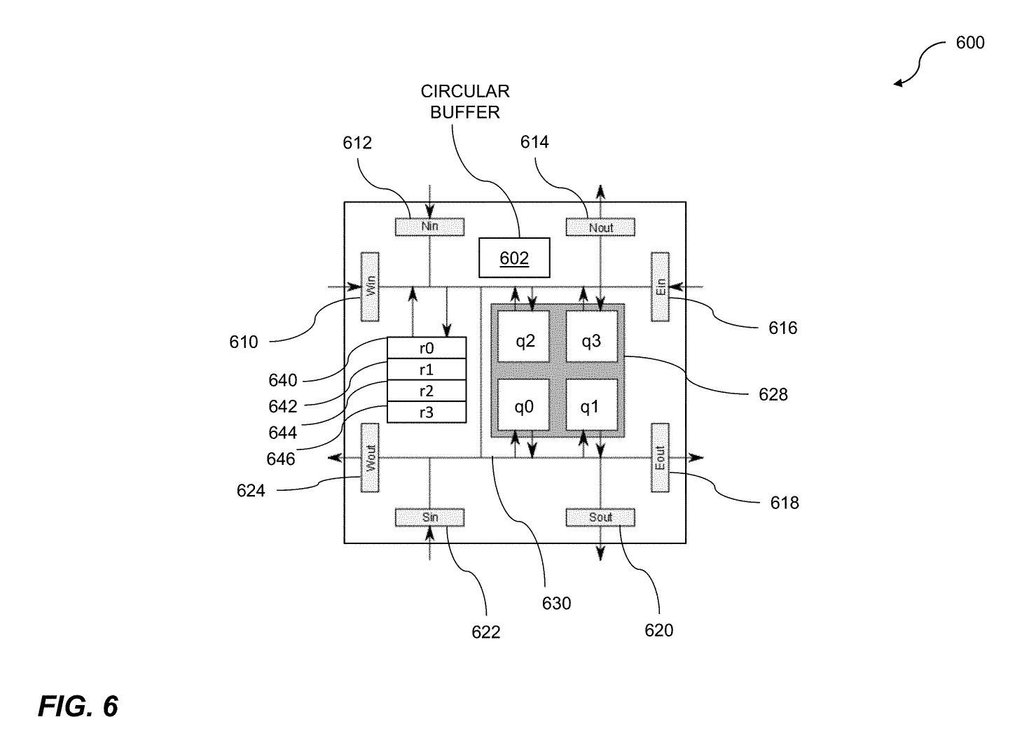

FIG. 6 shows a cluster for coarse-grained reconfigurable processing. The cluster for coarse-grained reconfigurable processing 600 can be used for matrix computation within a reconfigurable processor fabric. The matrix computation can include a first matrix (a multiplier matrix), and a second matrix (a multiplicand matrix), where the matrices are obtained for processing a reconfigurable fabric that includes a plurality of processing elements. The first matrix and the second matrix are partitioned, respectively, into a first set of submatrices and a second set of submatrices. The first set of submatrices can be distributed around a subset of the plurality of processing elements, where the subset of the plurality of processing elements includes a sequential path of adjacent processing elements. The sequential path forms a closed loop of processing elements starting and ending with a same first processing element. The second set of submatrices can be positioned around the subset of the plurality of processing elements. A partial matrix multiplication can be performed at each of the subsets of the plurality of processing elements that include a sequential path. A result is output by recomposing results of the partial matrix multiplication at the subset of the plurality of processing elements. The plurality of processing elements can include the sequential path into a product matrix. The results of the multiple partial matrix multiplications are recomposed into a product matrix.

The cluster 600 comprises a circular buffer 602. The circular buffer 602 can be referred to as a main circular buffer or a switch-instruction circular buffer. In some embodiments, the cluster 600 comprises additional circular buffers corresponding to processing elements within the cluster. The additional circular buffers can be referred to as processor instruction circular buffers. The example cluster 600 comprises a plurality of logical elements, configurable connections between the logical elements, and a circular buffer 602 controlling the configurable connections. The logical elements can further comprise one or more of switching elements, processing elements, or storage elements. The example cluster 600 also comprises four processing elements—q0, q1, q2, and q3. The four processing elements can collectively be referred to as a “quad,” and are jointly indicated by a grey reference box 628. In embodiments, there is intercommunication among and between each of the four processing elements. In embodiments, the circular buffer 602 controls the passing of data to the quad of processing elements 628 through switching elements. In embodiments, the four processing elements 628 comprise a processing cluster. In some cases, the processing elements can be placed into a sleep state. In embodiments, the processing elements wake up from a sleep state when valid data is applied to the inputs of the processing elements. In embodiments, the individual processors of a processing cluster share data and/or instruction caches. The individual processors of a processing cluster can implement message transfer via a bus or shared memory interface. Power gating can be applied to one or more processors (e.g. q1) in order to reduce power.

The cluster 600 can further comprise storage elements coupled to the configurable connections. As shown, the cluster 600 comprises four storage elements—r0 640, r1 642, r2 644, and r3 646. The cluster 600 further comprises a north input (Nin) 612, a north output (Nout) 614, an east input (Ein) 616, an east output (Eout) 618, a south input (Sin) 622, a south output (Sout) 620, a west input (Win) 610, and a west output (Wout) 624. The circular buffer 602 can contain switch instructions that implement configurable connections. For example, an instruction effectively connects the west input 610 with the north output 614 and the east output 618 and this routing is accomplished via bus 630. The cluster 600 can further comprise a plurality of circular buffers residing on a semiconductor chip where the plurality of circular buffers controls unique, configurable connections between and among the logical elements. The storage elements can include instruction random access memory (I-RAM) and data random access memory (D-RAM). The I-RAM and the D-RAM can be quad I-RAM and quad D-RAM, respectively, where the I-RAM and/or the D-RAM supply instructions and/or data, respectively, to the processing quad of a switching element.

A preprocessor or compiler can be configured to prevent data collisions within the circular buffer 602. The prevention of collisions can be accomplished by inserting no-op or sleep instructions into the circular buffer (pipeline). Alternatively, in order to prevent a collision on an output port, intermediate data can be stored in registers for one or more pipeline cycles before being sent out on the output port. In other situations, the preprocessor can change one switching instruction to another switching instruction to avoid a conflict. For example, in some instances, the preprocessor can change an instruction placing data on the west output 624 to an instruction placing data on the south output 620, such that the data can be output on both output ports within the same pipeline cycle. In a case where data needs to travel to a cluster that is both south and west of the cluster 600, it can be more efficient to send the data directly to the south output port rather than to store the data in a register first and then to send the data to the west output on a subsequent pipeline cycle.

An L2 switch interacts with the instruction set. A switch instruction typically has a source and a destination. Data is accepted from the source and is sent to the destination. There are several sources (e.g. any of the quads within a cluster, any of the L2 directions (North, East, South, West), a switch register, one of the quad RAMs (data RAM, IRAM, PE/Co Processor Register). As an example, to accept data from any L2 direction, a “valid” bit is used to inform the switch that the data flowing through the fabric is indeed valid. The switch will select the valid data from the set of specified inputs. For this to function properly, only one input can have valid data, and the other inputs must all be marked as invalid. It should be noted that this fan-in operation at the switch input operates independently for control and data. There is no requirement for a fan-in mux to select data and control bits from the same input source. Data valid bits are used to select valid data, and control valid bits are used to select the valid control input. There are many sources and destinations for the switching element, which can result in too many instruction combinations, so the L2 switch has a fan-in function enabling input data to arrive from one and only one input source. The valid input sources are specified by the instruction. Switch instructions are therefore formed by combining a number of fan-in operations and sending the result to a number of specified switch outputs.

In the event of a software error, multiple valid bits may arrive at an input. In this case, the hardware implementation can implement any safe function of the two inputs. For example, the fan-in could implement a logical OR of the input data. Any output data is acceptable because the input condition is an error, so long as no damage is done to the silicon. In the event that a bit is set to ‘1’ for both inputs, an output bit should also be set to ‘1’. A switch instruction can accept data from any quad or from any neighboring L2 switch. A switch instruction can also accept data from a register or a microDMA controller. If the input is from a register, the register number is specified. Fan-in may not be supported for many registers as only one register can be read in a given cycle. If the input is from a microDMA controller, a DMA protocol is used for addressing the resource.

For many applications, the reconfigurable fabric can be a DMA slave, which enables a host processor to gain direct access to the instruction and data RAMs (and registers) that are located within the quads in the cluster. DMA transfers are initiated by the host processor on a system bus. Several DMA paths can propagate through the fabric in parallel. The DMA paths generally start or finish at a streaming interface to the processor system bus. DMA paths may be horizontal, vertical, or a combination thereof (as determined by a router). To facilitate high bandwidth DMA transfers, several DMA paths can enter the fabric at different times, providing both spatial and temporal multiplexing of DMA channels. Some DMA transfers can be initiated within the fabric, enabling DMA transfers between the block RAMs without external supervision. It is possible for a cluster “A”, to initiate a transfer of data between cluster “B” and cluster “C” without any involvement of the processing elements in clusters “B” and “C”. Furthermore, cluster “A” can initiate a fan-out transfer of data from cluster “B” to clusters “C”, “D”, and so on, where each destination cluster writes a copy of the DMA data to different locations within their Quad RAMs. A DMA mechanism may also be used for programming instructions into the instruction RAMs.

Accesses to RAM in different clusters can travel through the same DMA path, but the transactions must be separately defined. A maximum block size for a single DMA transfer can be 8 KB. Accesses to data RAMs can be performed either when the processors are running, or while the processors are in a low power “sleep” state. Accesses to the instruction RAMs and the PE and Co-Processor Registers may be performed during configuration mode. The quad RAMs may have a single read/write port with a single address decoder, thus allowing access to them to be shared by the quads and the switches. The static scheduler (i.e. the router) determines when a switch is granted access to the RAMs in the cluster. The paths for DMA transfers are formed by the router by placing special DMA instructions into the switches and determining when the switches can access the data RAMs. A microDMA controller within each L2 switch is used to complete data transfers. DMA controller parameters can be programmed using a simple protocol that forms the “header” of each access.

In embodiments, the computations that can be performed on a cluster for coarse-grained reconfigurable processing can be represented by a data flow graph. Data flow processors, data flow processor elements, and the like are particularly well suited to processing the various nodes of data flow graphs. The data flow graphs can represent communications between and among agents, matrix computations, tensor manipulations, Boolean functions, and so on. Data flow processors can be applied to many applications where large amounts of data such as unstructured data are processed. Typical processing applications for unstructured data can include speech and image recognition, natural language processing, bioinformatics, customer relationship management, digital signal processing (DSP), graphics processing (GP), network routing, telemetry such as weather data, data warehousing, and so on. Data flow processors can be programmed using software and can be applied to highly advanced problems in computer science such as deep learning. Deep learning techniques can include an artificial neural network, a convolutional neural network, etc. The success of these techniques is highly dependent on large quantities of data for training and learning. The data-driven nature of these techniques is well suited to implementations based on data flow processors. The data flow processor can receive a data flow graph such as an acyclic data flow graph, where the data flow graph can represent a deep learning network. The data flow graph can be assembled at runtime, where assembly can include input/output, memory input/output, and so on. The assembled data flow graph can be executed on the dataflow processor.

The data flow processors can be organized in a variety of configurations. One configuration can include processing element quads with arithmetic units. A data flow processor can include one or more processing elements (PE). The processing elements can include a processor, a data memory, an instruction memory, communications capabilities, and so on. Multiple PEs can be grouped, where the groups can include pairs, quads, octets, etc. The PEs organized in arrangements such as quads can be coupled to arithmetic units, where the arithmetic units can be coupled to or included in data processing units (DPU). The DPUs can be shared between and among quads. The DPUs can provide arithmetic techniques to the PEs, communications between quads, and so on.

The data flow processors, including data flow processors arranged in quads, can be loaded with kernels. The kernels can be included in a data flow graph, for example. In order for the data flow processors to operate correctly, the quads can require reset and configuration modes. Processing elements can be configured into clusters of PEs. Kernels can be loaded onto PEs in the cluster, where the loading of kernels can be based on availability of free PEs, an amount of time to load the kernel, an amount of time to execute the kernel, and so on. Reset can begin with initializing up-counters coupled to PEs in a cluster of PEs. Each up-counter is initialized with a value of minus one plus the Manhattan distance from a given PE in a cluster to the end of the cluster. A Manhattan distance can include a number of steps to the east, west, north, and south. A control signal can be propagated from the start cluster to the end cluster. The control signal advances one cluster per cycle. When the counters for the PEs all reach 0 then the processors have been reset. The processors can be suspended for configuration, where configuration can include loading of one or more kernels onto the cluster. The processors can be enabled to execute the one or more kernels. Configuring mode for a cluster can include propagating a signal. Clusters can be preprogrammed to enter a configuration mode. Various techniques, including direct memory access (DMA) can be used to load instructions from the kernel into instruction memories of the PEs. The clusters that were preprogrammed into configuration mode can be preprogrammed to exit configuration mode. When configuration mode has been exited, execution of the one or more kernels loaded onto the clusters can commence.

Data flow processes that can be executed by data flow processors can be managed by a software stack. A software stack can include a set of subsystems, including software subsystems, which may be needed to create a software platform. The software platform can include a complete software platform. A complete software platform can include a set of software subsystems required to support one or more applications. A software stack can include both offline and online operations. Offline operations can include software subsystems such as compilers, linkers, simulators, emulators, and so on. The offline software subsystems can be included in a software development kit (SDK). The online operations can include data flow partitioning, data flow graph throughput optimization, and so on. The online operations can be executed on a session host and can control a session manager. Online operations can include resource management, monitors, drivers, etc. The online operations can be executed on an execution engine. The online operations can include a variety of tools which can be stored in an agent library. The tools can include BLAS™, CONV2D™, SoftMax™, and so on.

Software to be executed on a data flow processor can include precompiled software or agent generation. The precompiled agents can be stored in an agent library. An agent library can include one or more computational models which can simulate actions and interactions of autonomous agents. Autonomous agents can include entities such as groups, organizations, and so on. The actions and interactions of the autonomous agents can be simulated to determine how the agents can influence operation of a whole system. Agent source code can be provided from a variety of sources. The agent source code can be provided by a first entity, provided by a second entity, and so on. The source code can be updated by a user, downloaded from the Internet, etc. The agent source code can be processed by a software development kit, where the software development kit can include compilers, linkers, assemblers, simulators, debuggers, and so one. The agent source code that can be operated on by the software development kit (SDK) can be in an agent library. The agent source code can be created using a variety of tools, where the tools can include MATMUL™, Batchnorm™, Relu™ and so on. The agent source code that has been operated on can include functions, algorithms, heuristics, etc., that can be used to implement a deep learning system.

A software development kit can be used to generate code for the data flow processor or processors. The software development kit (SDK) can include a variety of tools which can be used to support a deep learning technique or other technique which requires processing of large amounts of data such as unstructured data. The SDK can support multiple machine learning techniques based on GAMM™, sigmoid, and so on. The SDK can include a low-level virtual machine (LLVM) which can serve as a front end to the SDK. The SDK can include a simulator. The SDK can include a Boolean satisfiability solver (SAT solver). The SAT solver can include a compiler, a linker, and so on. The SDK can include an architectural simulator, where the architectural simulator can simulate a data flow processor or processors. The SDK can include an assembler, where the assembler can be used to generate object modules. The object modules can represent agents. The agents can be stored in a library of agents. Other tools can be included in the SDK. The various techniques of the SDK can operate on various representations of a wave flow graph (WFG).

A reconfigurable fabric can include quads of elements. The elements of the reconfigurable fabric can include processing elements, switching elements, storage elements, and so on. An element such as a storage element can be controlled by a rotating circular buffer. In embodiments, the rotating circular buffer can be statically scheduled. The data operated on by the agents resident within the reconfigurable buffer can include tensors. Tensors can include one or more blocks. The reconfigurable fabric can be configured to process tensors, tensor blocks, tensors and blocks, etc. One technique for processing tensors includes deploying agents in a pipeline. That is, the output of one agent can be directed to the input of another agent. Agents can be assigned to clusters of quads, where the clusters can include one or more quads. Multiple agents can be pipelined when there are sufficient clusters of quads to which the agents can be assigned. Multiple pipelines can be deployed. Pipelining of the multiple agents can reduce the sizes of input buffers, output buffers, intermediate buffers, and other storage elements. Pipelining can further reduce memory bandwidth needs of the reconfigurable fabric.

Agents can be used to support dynamic reconfiguration of the reconfigurable fabric. The agents that support dynamic reconfiguration of the reconfigurable fabric can include interface signals in a control unit. The interface signals can include suspend, agent inputs empty, agent outputs empty, and so on. The suspend signal can be implemented using a variety of techniques such as a semaphore, a streaming input control signal, and the like. When a semaphore is used, the agent that is controlled by the semaphore can monitor the semaphore. In embodiments, a direct memory access (DMA) controller can wake the agent when the setting of the semaphore has been completed. The streaming control signal, if used, can wake a control unit if the control unit is sleeping. A response received from the agent can be configured to interrupt the host software.

The suspend semaphore can be asserted by runtime software in advance of commencing dynamic reconfiguration of the reconfigurable fabric. Upon detection of the semaphore, the agent can begin preparing for entry into a partially resident state. A partially resident state for the agent can include having the agent control unit resident after the agent kernel is removed. The agent can complete processing of any currently active tensor being operated on by the agent. In embodiments, a done signal and a fire signal may be sent to upstream or downstream agents, respectively. A done signal can be sent to the upstream agent to indicate that all data has been removed from its output buffer. A fire signal can be sent to a downstream agent to indicate that data in the output buffer is ready for processing by the downstream agent. The agent can continue to process incoming done signals and fire signals, but will not commence processing of any new tensor data after completion of the current tensor processing by the agent. The semaphore can be reset by the agent to indicate to a host that the agent is ready to be placed into partial residency. In embodiments, having the agent control unit resident after the agent kernel is removed comprises having the agent partially resident. A control unit may not assert one or more signals, nor expect one or more responses from a kernel in the agent, when a semaphore has been reset.

Other signals from an agent can be received by a host. The signals can include an agent inputs empty signal, an agent outputs empty signal, and so on. The agent inputs empty signal can be sent from the agent to the host and can indicate that the input buffers are empty. The agent inputs empty signal can only be sent from the agent when the agent is partially resident. The agent outputs empty signal can be sent from the agent to the host and can indicate that the output buffers are empty. The agent outputs empty can only be sent from the agent to the host when the agent is partially resident. When the runtime (host) software receives both signals, agent inputs empty and agent outputs empty, from the partially resident agent, the agent can be swapped out of the reconfigurable fabric and can become fully vacant.

Recall that an agent can be one of a plurality of agents that form a data flow graph. The data flow graph can be based on a plurality of subgraphs. The data flow graph can be based on agents which can support three states of residency: fully resident, partially resident, and fully vacant. A complete subsection (or subgraph) based on the agents that support the three states of residency can be swapped out of the reconfigurable fabric. The swapping out of the subsection can be based on asserting a suspend signal input to an upstream agent. The asserting of the suspend signal can be determined by the runtime software. When a suspend signal is asserted, the agent can stop consuming input data such as an input sensor. The tensor can queue within the input buffers of the agent. The agent kernel can be swapped out of the reconfigurable fabric, leaving the agent partially resident while the agent waits for the downstream agents to drain the output buffers for the agent. When an upstream agent is fully resident, the agent may not be able to be fully vacant because a fire signal might be sent to the agent by the upstream agent. When the upstream agent is partially resident or is fully vacant, then the agent can be fully vacated from the reconfigurable fabric. The agent can be fully vacated if it asserts both the signals “input buffers empty” and “output buffers empty”.

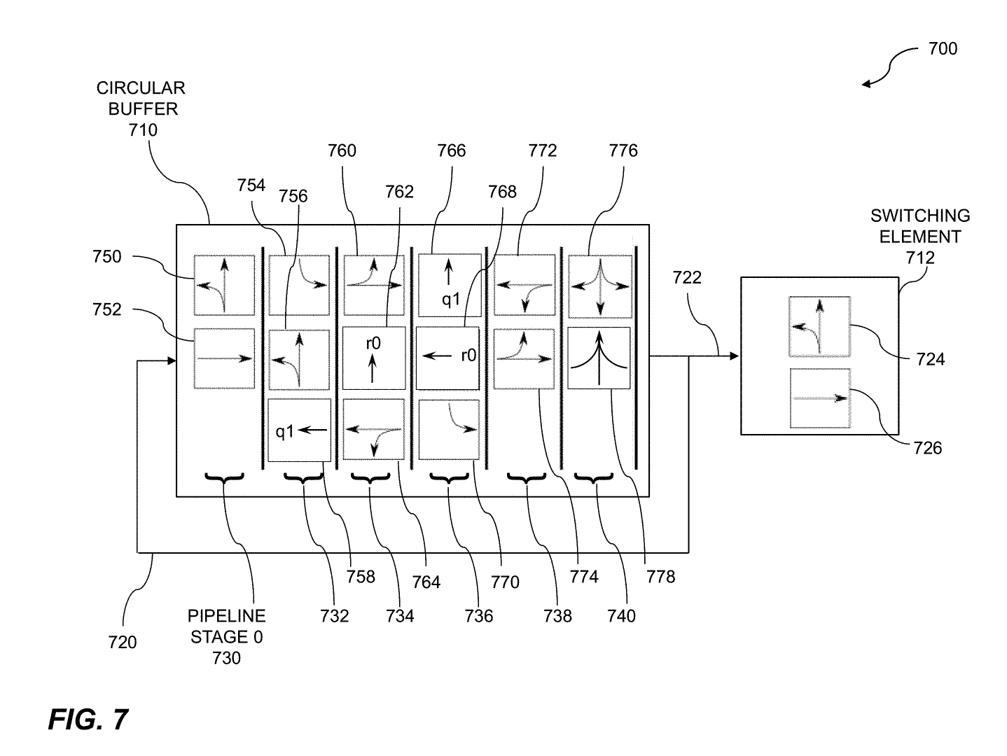

FIG. 7 shows a block diagram of a circular buffer. The circular buffer 700 can include a switching element 712 which corresponds to the circular buffer. The circular buffer and the corresponding switching element can be used in part for matrix computation within a reconfigurable processor fabric. Using the circular buffer 710 and the corresponding switching element 712, data can be obtained from a first switching unit, where the first switching unit can be controlled by a first circular buffer. Data can be sent to a second switching element, where the second switching element can be controlled by a second circular buffer. The obtaining data from the first switching element and the sending data to the second switching element can include a direct memory access (DMA). The block diagram 700 describes a processor-implemented method for data manipulation. The circular buffer 710 contains a plurality of pipeline stages. Each pipeline stage contains one or more instructions up to a maximum instruction depth. In the embodiment shown in FIG. 7, the circular buffer 710 is a 6×3 circular buffer, meaning that it implements a six-stage pipeline with an instruction depth of up to three instructions per stage (column). Hence, the circular buffer 710 can include one, two, or three switch instruction entries per column. In some embodiments, the plurality of switch instructions per cycle can comprise two or three switch instructions per cycle. However, in certain embodiments, the circular buffer 710 supports only a single switch instruction in a given cycle. In the example 700 shown, Pipeline Stage 0 730 has an instruction depth of two instructions 750 and 752. Though the remaining pipeline stages 1-5 are not textually labeled in the FIG. 700, the stages are indicated by callouts 732, 734, 736, 738, and 740. Pipeline stage 1 732 has an instruction depth of three instructions 754, 756, and 758. Pipeline stage 2 734 has an instruction depth of three instructions 760, 762, and 764. Pipeline stage 3 736 also has an instruction depth of three instructions 766, 768, and 770. Pipeline stage 4 738 has an instruction depth of two instructions 772 and 774. Pipeline stage 5 740 has an instruction depth of two instructions 776 and 778. In embodiments, the circular buffer 710 includes 64 columns. During operation, the circular buffer 710 rotates through configuration instructions. The circular buffer 710 can dynamically change operation of the logical elements based on the rotation of the circular buffer. The circular buffer 710 can comprise a plurality of switch instructions per cycle for the configurable connections.

The instruction 752 is an example of a switch instruction. In embodiments, each cluster has four inputs and four outputs, each designated within the cluster's nomenclature as “north,” “east,” “south,” and “west” respectively. For example, the instruction 752 in the diagram 700 is a west-to-east transfer instruction. The instruction 752 directs the cluster to take data on its west input and send out the data on its east output. In another example of data routing, the instruction 750 is a fan-out instruction. The instruction 750 instructs the cluster to take data from its south input and send out on the data through both its north output and its west output. The arrows within each instruction box indicate the source and destination of the data. The instruction 778 is an example of a fan-in instruction. The instruction 778 takes data from the west, south, and east inputs and sends out the data on the north output. Therefore, the configurable connections can be considered to be time multiplexed.

In embodiments, the clusters implement multiple storage elements in the form of registers. In the example 700 shown, the instruction 762 is a local storage instruction. The instruction 762 takes data from the instruction's south input and stores it in a register (r0). Another instruction (not shown) is a retrieval instruction. The retrieval instruction takes data from a register (e.g. r0) and outputs it from the instruction's output (north, south, east, west). Some embodiments utilize four general purpose registers, referred to as registers r0, r1, r2, and r3. The registers are, in embodiments, storage elements which store data while the configurable connections are busy with other data. In embodiments, the storage elements are 32-bit registers. In other embodiments, the storage elements are 64-bit registers. Other register widths are possible.

The obtaining data from a first switching element and the sending the data to a second switching element can include a direct memory access (DMA). A DMA transfer can continue while valid data is available for the transfer. A DMA transfer can terminate when it has completed without error, or when an error occurs during operation. Typically, a cluster that initiates a DMA transfer will request to be brought out of sleep state when the transfer is complete. This waking is achieved by setting control signals that can control the one or more switching elements. Once the DMA transfer is initiated with a start instruction, a processing element or switching element in the cluster can execute a sleep instruction to place itself to sleep. When the DMA transfer terminates, the processing elements and/or switching elements in the cluster can be brought out of sleep after the final instruction is executed. Note that if a control bit can be set in the register of the cluster that is operating as a slave in the transfer, that cluster can also be brought out of sleep state if it is asleep during the transfer.

The cluster that is involved in a DMA and can be brought out of sleep after the DMA controller can determine that it has been brought out of a sleep state based on the code that is executed. A cluster can be brought out of a sleep state based on the arrival of a reset signal and the execution of a reset instruction. The cluster can be brought out of sleep by the arrival of valid data (or control) following the execution of a switch instruction. A processing element or switching element can determine why it was brought out of a sleep state by the context of the code that the element starts to execute. A cluster can be awoken during a DMA operation by the arrival of valid data. The DMA instruction can be executed while the cluster remains asleep and awaits the arrival of valid data. Upon arrival of the valid data, the cluster is woken and the data stored. Accesses to one or more data random access memories (RAM) can be performed when the processing elements and the switching elements are operating. The accesses to the data RAMs can also be performed while the processing elements and/or switching elements are in a low power sleep state.

In embodiments, the clusters implement multiple processing elements in the form of processor cores, referred to as cores q0, q1, q2, and q3. In embodiments, four cores are used, though any number of cores can be implemented. The instruction 758 is a processing instruction. The instruction 758 takes data from the instruction's east input and sends it to a processor q1 for processing. The processors can perform logic operations on the data, including, but not limited to, a shift operation, a logical AND operation, a logical OR operation, a logical NOR operation, a logical XOR operation, an addition, a subtraction, a multiplication, and a division. Thus, the configurable connections can comprise one or more of a fan-in, a fan-out, and a local storage.

In the example 700 shown, the circular buffer 710 rotates instructions in each pipeline stage into switching element 712 via a forward data path 722, and also back to a pipeline stage 0 730 via a feedback data path 720. Instructions can include switching instructions, storage instructions, and processing instructions, among others. The feedback data path 720 can allow instructions within the switching element 712 to be transferred back to the circular buffer. Hence, the instructions 724 and 726 in the switching element 712 can also be transferred back to pipeline stage 0 as the instructions 750 and 752. In addition to the instructions depicted on FIG. 7, a no-op instruction can also be inserted into a pipeline stage. In embodiments, a no-op instruction causes execution to not be performed for a given cycle. In effect, the introduction of a no-op instruction can cause a column within the circular buffer 710 to be skipped in a cycle. In contrast, not skipping an operation indicates that a valid instruction is being pointed to in the circular buffer. A sleep state can be accomplished by not applying a clock to a circuit, performing no processing within a processor, removing a power supply voltage or bringing a power supply to ground, storing information into a non-volatile memory for future use and then removing power applied to the memory, or by similar techniques. A sleep instruction that causes no execution to be performed until a predetermined event occurs which causes the logical element to exit the sleep state can also be explicitly specified. The predetermined event can be the arrival or availability of valid data. The data can be determined to be valid using null convention logic (NCL). In embodiments, only valid data can flow through the switching elements and invalid data points (Xs) are not propagated by instructions.

In some embodiments, the sleep state is exited based on an instruction applied to a switching fabric. The sleep state can, in some embodiments, only be exited by a stimulus external to the logical element and not based on the programming of the logical element. The external stimulus can include an input signal, which in turn can cause a wake up or an interrupt service request to execute on one or more of the logical elements. An example of such a wake-up request can be seen in the instruction 758, assuming that the processor q1 was previously in a sleep state. In embodiments, when the instruction 758 takes valid data from the east input and applies that data to the processor q1, the processor q1 wakes up and operates on the received data. In the event that the data is not valid, the processor q1 can remain in a sleep state. At a later time, data can be retrieved from the q1 processor, e.g. by using an instruction such as the instruction 766. In the case of the instruction 766, data from the processor q1 is moved to the north output. In some embodiments, if Xs have been placed into the processor q1, such as during the instruction 758, then Xs would be retrieved from the processor q1 during the execution of the instruction 766 and applied to the north output of the instruction 766.

A collision occurs if multiple instructions route data to a particular port in a given pipeline stage. For example, if instructions 752 and 754 are in the same pipeline stage, they will both send data to the east output at the same time, thus causing a collision since neither instruction is part of a time-multiplexed fan-in instruction (such as the instruction 778). To avoid potential collisions, certain embodiments use preprocessing, such as by a compiler, to arrange the instructions in such a way that there are no collisions when the instructions are loaded into the circular buffer. Thus, the circular buffer 710 can be statically scheduled in order to prevent data collisions. In embodiments, the circular buffers are statically scheduled. In embodiments, when the preprocessor detects a data collision, the scheduler changes the order of the instructions to prevent the collision. Alternatively, or additionally, the preprocessor can insert further instructions such as storage instructions (e.g. the instruction 762), sleep instructions, or no-op instructions, to prevent the collision. Alternatively, or additionally, the preprocessor can replace multiple instructions with a single fan-in instruction. For example, if a first instruction sends data from the south input to the north output and a second instruction sends data from the west input to the north output in the same pipeline stage, the first and second instruction can be replaced with a fan-in instruction that routes the data from both of those inputs to the north output in a deterministic way to avoid a data collision. In this case, the machine can guarantee that valid data is only applied on one of the inputs for the fan-in instruction.

Returning to DMA, a channel configured as a DMA channel requires a flow control mechanism that is different from regular data channels. A DMA controller can be included in interfaces to master DMA transfer through the processing elements and switching elements. For example, if a read request is made to a channel configured as DMA, the Read transfer is mastered by the DMA controller in the interface. It includes a credit count that monitors the number of records in a transmit (Tx) FIFO that are known to be available. The credit count is initialized based on the size of the Tx FIFO. When a data record is removed from the Tx FIFO, the credit count is increased. If the credit count is positive, and the DMA transfer is not complete, an empty data record can be inserted into a receive (Rx) FIFO. The memory bit is set to indicate that the data record should be populated with data by the source cluster. If the credit count is zero (meaning the Tx FIFO is full), no records are entered into the Rx FIFO. The FIFO to fabric block will ensure that the memory bit is reset to 0 and will thereby prevent a microDMA controller in the source cluster from sending more data.

Each slave interface manages four interfaces between the FIFOs and the fabric. Each interface can contain up to 15 data channels. Therefore, a slave should manage read/write queues for up to 60 channels. Each channel can be programmed to be a DMA channel, or a streaming data channel. DMA channels are managed using a DMA protocol. Streaming data channels are expected to maintain their own form of flow control using the status of the Rx FIFOs (obtained using a query mechanism). Read requests to slave interfaces use one of the flow control mechanisms described previously.

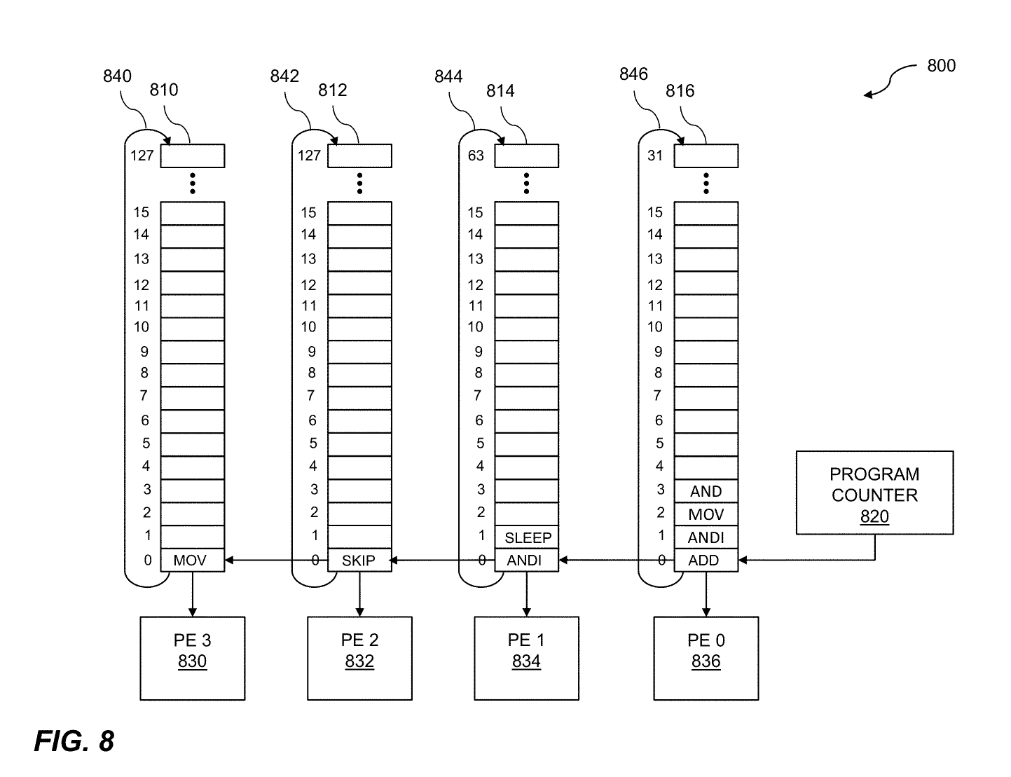

FIG. 8 illustrates a circular buffer and processing elements. A diagram 800 indicates example instruction execution for processing elements. The processing elements can include a portion of or all of the elements within a reconfigurable fabric. The instruction execution can include instructions for multithreaded data flow processing within a reconfigurable fabric. A circular buffer 810 feeds a processing element 830. A second circular buffer 812 feeds another processing element 832. A third circular buffer 814 feeds another processing element 834. A fourth circular buffer 816 feeds another processing element 836. These circular buffers are shown with lengths of 128, 64, and 32 entries, but various lengths are possible. The four processing elements 830, 832, 834, and 836 can represent a quad of processing elements. In embodiments, the processing elements 830, 832, 834, and 836 are controlled by instructions received from the circular buffers 810, 812, 814, and 816, respectively. The circular buffers can be implemented using feedback paths 840, 842, 844, and 846, respectively. In embodiments, the circular buffer can control the passing of data to a quad of processing elements through switching elements, where each of the quad of processing elements is controlled by four other circular buffers (as shown in the circular buffers 810, 812, 814, and 816) and where data is passed back through the switching elements from the quad of processing elements where the switching elements are again controlled by the main circular buffer. In embodiments, a program counter 820 is configured to point to the current instruction within a circular buffer. In embodiments with a configured program counter, the contents of the circular buffer are not shifted or copied to new locations on each instruction cycle. Rather, the program counter 820 is incremented in each cycle to point to a new location in the circular buffer. The circular buffers 810, 812, 814, and 816 can contain instructions for the processing elements. The instructions can include, but are not limited to, move instructions, skip instructions, logical AND instructions, logical AND-Invert (e.g. ANDI) instructions, logical OR instructions, mathematical ADD instructions, shift instructions, sleep instructions, and so on. A sleep instruction can be usefully employed in numerous situations. The sleep state can be entered by an instruction within one of the processing elements. One or more of the processing elements can be in a sleep state at any given time. In some embodiments, a “skip” can be performed on an instruction and the instruction in the circular buffer can be ignored and the corresponding operation not performed.

The plurality of circular buffers can have differing lengths. That is, the plurality of circular buffers can comprise circular buffers of differing sizes. In embodiments, the circular buffers 810 and 812 have a length of 128 instructions, the circular buffer 814 has a length of 64 instructions, and the circular buffer 816 has a length of 32 instructions, but other circular buffer lengths are also possible. In some embodiments, all buffers have the same length. The plurality of circular buffers that have differing lengths can resynchronize with a zeroth pipeline stage for each of the plurality of circular buffers. The circular buffers of differing sizes can restart at a same time step. In other embodiments, the plurality of circular buffers includes a first circular buffer repeating at one frequency and a second circular buffer repeating at a second frequency. In this situation, the first circular buffer is of one length. When the first circular buffer finishes through a loop, it can restart operation at the beginning, even though the second, longer circular buffer has not yet completed its operations. When the second circular buffer reaches completion of its loop of operations, the second circular buffer can restart operations from its beginning.

As can be seen in FIG. 8, different circular buffers can have different instruction sets within them. For example, the first circular buffer 810 contains a MOV instruction. The second circular buffer 812 contains a SKIP instruction. The third circular buffer 814 contains a SLEEP instruction and an ANDI instruction. The fourth circular buffer 816 contains an AND instruction, a MOVE instruction, an ANDI instruction, and an ADD instruction. The operations performed by the processing elements 830, 832, 834, and 836 are dynamic and can change over time, based on the instructions loaded into the respective circular buffers. As the circular buffers rotate, new instructions can be executed by the respective processing element.

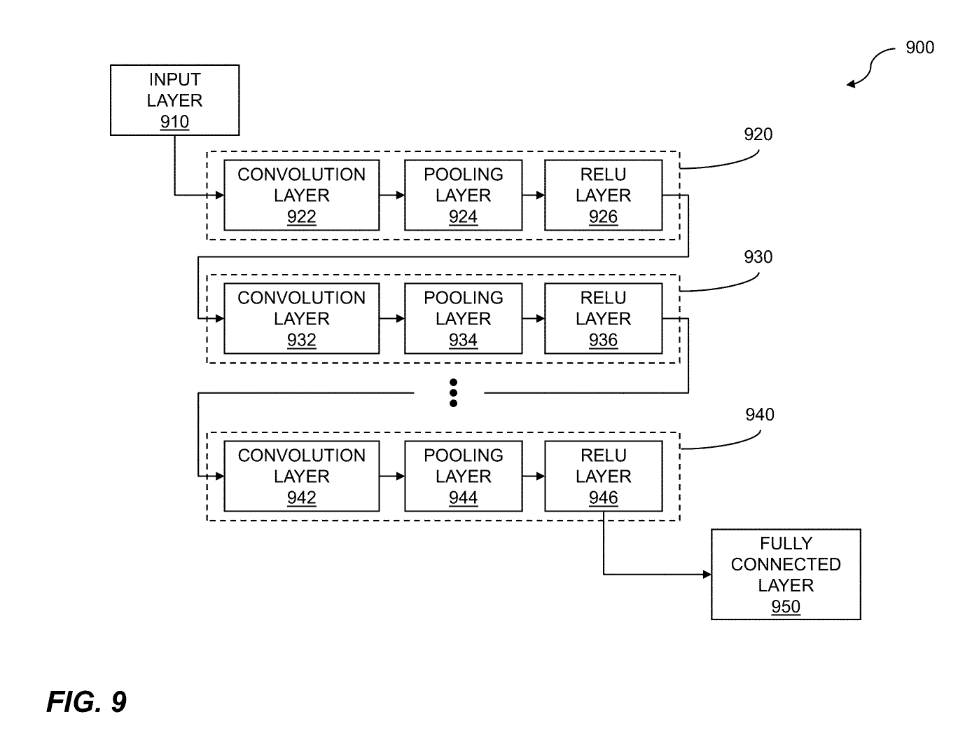

FIG. 9 shows a deep learning block diagram. The deep learning block diagram 900 can include a neural network such as a deep neural network (DNN), a convolutional neural network, and so on. A convolutional neural network can be based on layers, where the layers can include input layers, output layers, fully connected layers, convolution layers, pooling layers, rectified linear unit (ReLU) layers, and so on. The layers of the convolutional network can be implemented using a reconfigurable fabric. The reconfigurable fabric can include processing elements, switching elements, storage elements, etc. The reconfigurable fabric can be used to perform matrix computations based on submatrices. Deep learning can be applied to matrix computation within a reconfigurable processor fabric.

A deep learning block diagram 900 is shown. The block diagram can include various layers, where the layers can include an input layer, hidden layers, a fully connected layer, and so on. In some embodiments, the deep learning block diagram can include a classification layer. The input layer 910 can receive input data, where the input data can include a first collected data group, a second collected data group, a third collected data group, a fourth collected data group, etc. The collecting of the data groups can be performed in a first locality, a second locality, a third locality, a fourth locality, and so on, respectively. The input layer can then perform processing such as partitioning collected data into non-overlapping partitions. The deep learning block diagram 900, which can represent a network such as a convolutional neural network, can contain a plurality of hidden layers. While three hidden layers, hidden layer 920, hidden layer 930, and hidden layer 940 are shown, other numbers of hidden layers may be present. Each hidden layer can include layers that perform various operations, where the various layers can include a convolution layer, a pooling layer, and a rectifier layer such as a rectified linear unit (ReLU) layer. Thus, layer 920 can include convolution layer 922, pooling layer 924, and ReLU layer 926; layer 930 can include convolution layer 932, pooling layer 934, and ReLU layer 936; and layer 940 can include convolution layer 942, pooling layer 944, and ReLU layer 946. The convolution layers 922, 932, and 942 can perform convolution operations; the pooling layers 924, 934, and 944 can perform pooling operations, including max pooling, such as data down-sampling; and the ReLU layers 926, 936, and 946 can perform rectification operations. A convolutional layer can reduce the amount of data feeding into a fully connected layer. The block diagram 900 can include a fully connected layer 950. The fully connected layer can be connected to each data point from the one or more convolutional layers.

Data flow processors can be implemented within a reconfigurable fabric. Data flow processors can be applied to many applications where large amounts of data such as unstructured data are processed. Typical processing applications for unstructured data can include speech and image recognition, natural language processing, bioinformatics, customer relationship management, digital signal processing (DSP), graphics processing (GP), network routing, telemetry such as weather data, data warehousing, and so on. Data flow processors can be programmed using software and can be applied to highly advanced problems in computer science such as deep learning. Deep learning techniques can include an artificial neural network, a convolutional neural network, etc. The success of these techniques is highly dependent on large quantities of data for training and learning. The data-driven nature of these techniques is well suited to implementations based on dataflow processors. The data flow processor can receive a data flow graph such as an acyclic data flow graph, where the data flow graph can represent a deep learning network. The data flow graph can be assembled at runtime, where assembly can include input/output, memory input/output, and so on. The assembled data flow graph can be executed on the dataflow processor.

The data flow processors can be organized in a variety of configurations. One configuration can include processing element quads with arithmetic units. A data flow processor can include one or more processing elements (PEs). The processing elements can include a processor, a data memory, an instruction memory, communications capabilities, and so on. Multiple PEs can be grouped, where the groups can include pairs, quads, octets, etc. The PEs arranged in arrangements such as quads can be coupled to arithmetic units, where the arithmetic units can be coupled to or included in data processing units (DPU). The DPUs can be shared between and among quads. The DPUs can provide arithmetic techniques to the PEs, communications among quads, and so on.

The data flow processors, including data flow processors arranged in quads, can be loaded with kernels. The kernels can be included in a data flow graph, for example. In order for the data flow processors to operate correctly, the quads can require reset and configuration modes. Processing elements can be configured into clusters of PEs. Kernels can be loaded onto PEs in the cluster, where the loading of kernels can be based on availability of free PEs, an amount of time to load the kernel, an amount of time to execute the kernel, and so on. Reset can begin with initializing up-counters coupled to PEs in a cluster of PEs. Each up-counter is initialized with a value of minus one plus the Manhattan distance from a given PE in a cluster to the end of the cluster. A Manhattan distance can include a number of steps to the east, west, north, and south. A control signal can be propagated from the start cluster to the end cluster. The control signal advances one cluster per cycle. When the counters for the PEs all reach 0 then the processors have been reset. The processors can be suspended for configuration, where configuration can include loading one or more kernels onto the cluster. The processors can be enabled to execute the one or more kernels. Configuring mode for a cluster can include propagating a signal. Clusters can be preprogrammed to enter a configuration mode. Various techniques, including direct memory access (DMA) can be used to load instructions from the kernel into instruction memories of the PEs. The clusters that were preprogrammed into configuration mode can be preprogrammed to exit configuration mode. When configuration mode has been exited, execution of the one or more kernels loaded onto the clusters can commence.

Data flow processes executed by data flow processors can be managed by a software stack. A software stack can include a set of subsystems, including software subsystems, which may be needed to create a software platform. The software platform can include a complete software platform. A complete software platform can include a set of software subsystems required to support one or more applications. A software stack can include offline operations and online operations. Offline operations can include software subsystems such as compilers, linkers, simulators, emulators, and so on. The offline software subsystems can be included in a software development kit (SDK). The online operations can include data flow partitioning, data flow graph throughput optimization, and so on. The online operations can be executed on a session host and can control a session manager. Online operations can include resource management, monitors, drivers, etc. The online operations can be executed on an execution engine. The online operations can include a variety of tools which can be stored in an agent library. The tools can include BLAS™, CONV2D™, SoftMax™, and so on.

Software to be executed on a data flow processor can include precompiled software or agent generation. The precompiled agents can be stored in an agent library. An agent library can include one or more computational models which can simulate actions and interactions of autonomous agents. Autonomous agents can include entities such as groups, organizations, and so on. The actions and interactions of the autonomous agents can be simulated to determine how the agents can influence operation of a whole system. Agent source code can be provided from a variety of sources. The agent source code can be provided by a first entity, provided by a second entity, and so on. The source code can be updated by a user, downloaded from the Internet, etc. The agent source code can be processed by a software development kit, where the software development kit can include compilers, linkers, assemblers, simulators, debuggers, and so one. The agent source code that can be operated on by the software development kit (SDK) can be in an agent library. The agent source code can be created using a variety of tools, where the tools can include MATMUL™, Batchnorm™, Relu™ and so on. The agent source code that has been operated on can include functions, algorithms, heuristics, etc., that can be used to implement a deep learning system.

A software development kit can be used to generate code for the data flow processor or processors. The software development kit (SDK) can include a variety of tools which can be used to support a deep learning technique or other technique which requires processing of large amounts of data such as unstructured data. The SDK can support multiple machine learning techniques such as machine learning techniques based on GAMM™, sigmoid, and so on. The SDK can include a low-level virtual machine (LLVM) which can serve as a front end to the SDK. The SDK can include a simulator. The SDK can include a Boolean satisfiability solver (SAT solver). The SAT solver can include a compiler, a linker, and so on. The SDK can include an architectural simulator, where the architectural simulator can simulate a data flow processor or processors. The SDK can include an assembler, where the assembler can be used to generate object modules. The object modules can represent agents. The agents can be stored in a library of agents. Other tools can be included in the SDK. The various techniques of the SDK can operate on various representations of a wave flow graph (WFG).

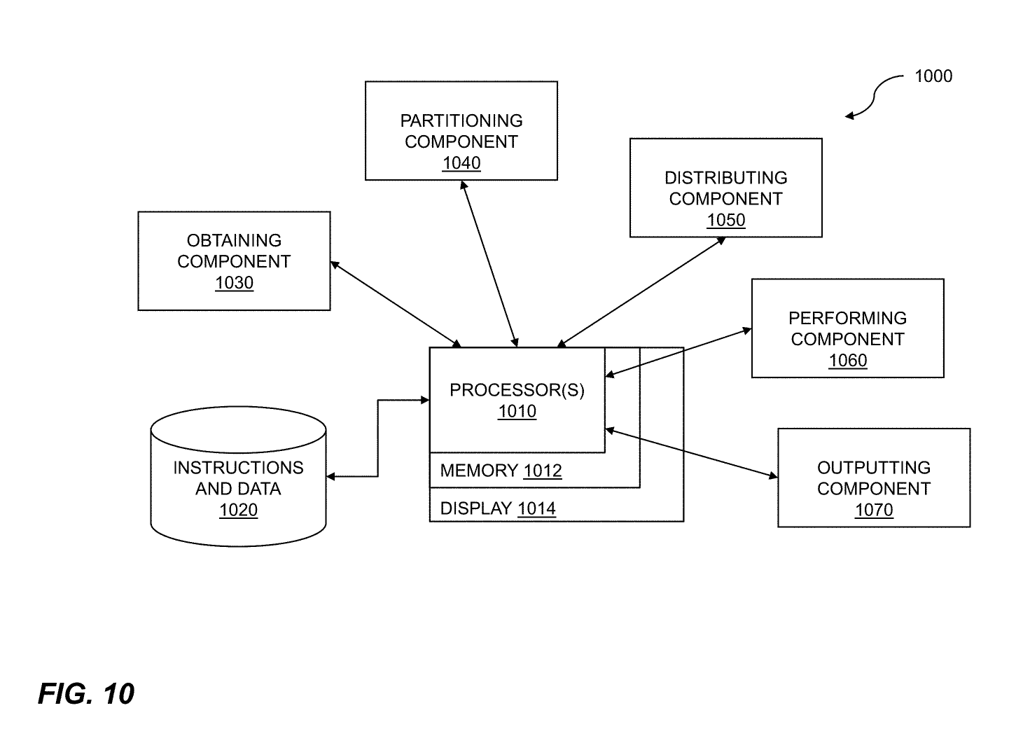

FIG. 10 is a system diagram for matrix computation within a reconfigurable processor fabric. The system 1000 can include one or more processors 1010 coupled to a memory 1012 which stores instructions. The system 1000 can include a display 1014 coupled to the one or more processors 1010 for displaying data, intermediate steps, instructions, and so on. In embodiments, one or more processors 1010 are attached to the memory 1012 where the one or more processors, when executing the instructions which are stored, are configured to: obtain, for processing on a reconfigurable fabric comprised of a plurality of processing elements, a first matrix, wherein the first matrix comprises a multiplier matrix; obtain, for processing on the reconfigurable fabric, a second matrix, wherein the second matrix comprises a multiplicand matrix; partition the first matrix and the second matrix, respectively, into a first set of submatrices and a second set of submatrices; distribute the first set of submatrices around a subset of the plurality of processing elements, wherein the subset of the plurality of processing elements comprises a sequential path of adjacent processing elements within the reconfigurable fabric, wherein the sequential path forms a closed loop of processing elements starting and ending with a same first processing element; distribute the second set of submatrices around the subset of the plurality of processing elements; perform a partial matrix multiplication at each of the subset of the plurality of processing elements that comprise a sequential path, wherein a portion of the second set of submatrices is sequentially rotated through the subset of the plurality of processing elements; and output a result by recomposing results of the partial matrix multiplication at the subset of the plurality of processing elements that comprise the sequential path into a product matrix.

The system 1000 can include a collection of instructions and data 1020. The instructions and data 1020 may be stored in a database, one or more statically linked libraries, one or more dynamically linked libraries, precompiled headers, source code, flow graphs, kernels, agents, or other suitable formats. The instructions can include instructions for matrix computation within a reconfigurable processor fabric. The data can include unstructured data, tensors, layers and weights, etc. The instructions can include a static schedule for controlling one or more rotating circular buffers. The system 1000 can include an obtaining component 1030. The obtaining component 1030 can include functions, instructions, or code for obtaining a first matrix and a second matrix. The first matrix can include a multiplier matrix, and the second matrix can include a multiplicand matrix. The first matrix can be obtained for processing on a reconfigurable fabric that includes a plurality of processing elements. The second matrix can be obtained for processing on a reconfigurable fabric that includes a plurality of processing elements. The processing of the first matrix and the processing of the second matrix can include partitioning either matrix, padding a matrix, and so on. The reconfigurable processor fabric can further include storage elements, switching elements, and so on. The partitioning can include padding one or more of the first submatrices with zeros when the first matrix partitions unevenly into submatrices around a ring. The system 1000 can include a partitioning component 1040. The partitioning component 1040 can include functions and instructions for partitioning the first matrix and the second matrix, respectively, into a first set of submatrices and a second set of submatrices. The partitioning can include partitioning the first matrix and the second matrix info submatrices that include 2×2 submatrices. The partitioning can include adding one or more dummy submatrices to the second set of submatrices when the number of second-set submatrices is less than the number of first-set submatrices.

The system 1000 can include a distributing component 1050. The distributing component 1050 can include functions and instructions for distributing the first set of submatrices around a subset of the plurality of processing elements. The subset of the plurality of processing elements includes a sequential path of adjacent processing elements within the reconfigurable fabric. The sequential path forms a closed loop of processing elements starting and ending with a same first processing element. The distributing component can include functions and instructions for distributing the second set of submatrices around the subset of the plurality of processing elements. The first set of processing elements and the second set of processing elements can include quads, work groups, and so on, within the reconfigurable fabric. The system 1000 can include a performing component 1060. The performing component can include functions and instructions for performing a partial matrix multiplication at each of the subsets of the plurality of processing elements that comprise a sequential path. A portion of the second set of submatrices is sequentially rotated through the subset of the plurality of processing elements. The partial matrix multiplication can include a multiply-accumulate function. In embodiments, the performing the partial matrix multiplication can be accomplished using the first set of submatrices and the portion of the second set of submatrices. Partial products from the partial multiplication can be accumulated in a multiply-accumulate component (not shown). Further embodiments include performing a second partial matrix multiplication at each of the subsets of the plurality of processing elements. The flow 1000 can include an outputting component 1070. The outputting component can include functions and instructions for outputting a result by recomposing results of the partial matrix multiplication at the subset of the plurality of processing elements that comprise the sequential path into a product matrix. In embodiments, the recomposing can be performed after the partial matrix multiplication and the second partial matrix multiplication. The recomposing can be performed within the reconfigurable fabric of processing elements or beyond the reconfigurable fabric. In embodiments, the recomposing can be accomplished using direct memory access (DMA) operations from the subset of the plurality of processing elements into another memory. The other memory can be memory coupled to the reconfigurable fabric of processing elements or can be located remotely from the reconfigurable fabric. The remote memory can be accessed wirelessly, using wires, or through another technique appropriate for data transfer.

The system 1000 can include a computer program product embodied in a non-transitory computer readable medium for matrix manipulation, the computer program product comprising code which causes one or more processors to perform operations of: obtaining, for processing on a reconfigurable fabric comprised of a plurality of processing elements, a first matrix, wherein the first matrix comprises a multiplier matrix; obtaining, for processing on the reconfigurable fabric, a second matrix, wherein the second matrix comprises a multiplicand matrix; partitioning the first matrix and the second matrix, respectively, into a first set of submatrices and a second set of submatrices; distributing the first set of submatrices around a subset of the plurality of processing elements, wherein the subset of the plurality of processing elements comprises a sequential path of adjacent processing elements within the reconfigurable fabric, wherein the sequential path forms a closed loop of processing elements starting and ending with a same first processing element; distributing the second set of submatrices around the subset of the plurality of processing elements; performing a partial matrix multiplication at each of the subset of the plurality of processing elements that comprise a sequential path, wherein a portion of the second set of submatrices is sequentially rotated through the subset of the plurality of processing elements; and outputting a result by recomposing results of the partial matrix multiplication at the subset of the plurality of processing elements that comprise the sequential path into a product matrix.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”— may be implemented by computer program instructions, by special-purpose hardware-based computer systems, by combinations of special purpose hardware and computer instructions, by combinations of general purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are neither limited to conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM), an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for matrix manipulation comprising:
obtaining, for processing on a reconfigurable fabric comprised of a plurality of processing elements, a first matrix, wherein the first matrix comprises a multiplier matrix;
obtaining, for processing on the reconfigurable fabric, a second matrix, wherein the second matrix comprises a multiplicand matrix;
partitioning the first matrix and the second matrix, respectively, into a first set of submatrices and a second set of submatrices;
distributing the first set of submatrices around a subset of the plurality of processing elements, wherein the subset of the plurality of processing elements comprises a sequential path of adjacent processing elements within the reconfigurable fabric, wherein the sequential path forms a closed loop of processing elements starting and ending with a same first processing element;
distributing the second set of submatrices around the subset of the plurality of processing elements;
performing a partial matrix multiplication at each of the subset of the plurality of processing elements that comprise a sequential path, wherein a portion of the second set of submatrices is sequentially rotated through the subset of the plurality of processing elements; and
outputting a result by recomposing results of the partial matrix multiplication at the subset of the plurality of processing elements that comprises the sequential path into a product matrix.

2. The method of claim 1 wherein the performing the partial matrix multiplication is accomplished using the first set of submatrices and the portion of the second set of submatrices.

3. The method of claim 2 further comprising performing a second partial matrix multiplication at each of the subset of the plurality of processing elements.

4. The method of claim 3 wherein the second partial matrix multiplication is accomplished using the first set of submatrices and a second portion of the second set of submatrices.

5. The method of claim 4 wherein the second portion of the second set of submatrices is sequentially rotated through the subset of the plurality of processing elements.

6. The method of claim 3 wherein the recomposing is performed after the partial matrix multiplication and the second partial matrix multiplication.

7. (canceled)

8. The method of claim 1 wherein the distributing of the first set of submatrices and the distributing of the second set of submatrices is accomplished using direct memory access (DMA) operations from another memory into the subset of the plurality of processing elements.

9. The method of claim 1 wherein the partitioning the first matrix separates the first matrix into pairs of columns.

10. The method of claim 1 wherein the partitioning the first matrix separates the first matrix into pairs of rows.

11. The method of claim 1 wherein the partitioning the second matrix separates the second matrix into pairs of columns.

12. The method of claim 1 wherein the partitioning the second matrix separates the second matrix into pairs of rows.

13. The method of claim 1 wherein each submatrix of the first set of submatrices is a square matrix with smaller dimensions than the first matrix.

14. The method of claim 13 wherein the square matrix dimension of the first set of submatrices is a power of 2.

15. (canceled)

16. The method of claim 1 wherein each submatrix of the second set of submatrices is a square matrix with smaller dimensions than the second matrix.

17. The method of claim 16 wherein the square matrix dimension of the second set of submatrices is a power of 2.

18. (canceled)

19. The method of claim 1 wherein the partitioning is done on a row basis.

20. The method of claim 1 wherein the partial matrix multiplication comprises a multiply-accumulate function.

21. The method of claim 1 further comprising padding one or more of the first set of submatrices with zeros when the first matrix partitions unevenly into submatrices around a ring defined by the distributing.

22. The method of claim 1 further comprising adding one or more dummy submatrices to the second set of submatrices when the number of second-set submatrices is less than the number of first-set submatrices.

23-25. (canceled)

26. The method of claim 1 wherein the processing elements are controlled by a rotating circular buffer.

27. (canceled)

28. The method of claim 26 wherein the processing elements each complete their multiply operation in one tick cycle.

29-35. (canceled)

36. A computer program product embodied in a non-transitory computer readable medium for matrix manipulation, the computer program product comprising code which causes one or more processors to perform operations of:
obtaining, for processing on a reconfigurable fabric comprised of a plurality of processing elements, a first matrix, wherein the first matrix comprises a multiplier matrix;
obtaining, for processing on the reconfigurable fabric, a second matrix, wherein the second matrix comprises a multiplicand matrix;
partitioning the first matrix and the second matrix, respectively, into a first set of submatrices and a second set of submatrices;
distributing the first set of submatrices around a subset of the plurality of processing elements, wherein the subset of the plurality of processing elements comprises a sequential path of adjacent processing elements within the reconfigurable fabric, wherein the sequential path forms a closed loop of processing elements starting and ending with a same first processing element;
distributing the second set of submatrices around the subset of the plurality of processing elements;
performing a partial matrix multiplication at each of the subset of the plurality of processing elements that comprise a sequential path, wherein a portion of the second set of submatrices is sequentially rotated through the subset of the plurality of processing elements; and
outputting a result by recomposing results of the partial matrix multiplication at the subset of the plurality of processing elements that comprise the sequential path into a product matrix.

37. A computer system for matrix manipulation comprising:
a memory which stores instructions;
one or more processors attached to the memory wherein the one or more processors, when executing the instructions which are stored, are configured to:
obtain, for processing on a reconfigurable fabric comprised of a plurality of processing elements, a first matrix, wherein the first matrix comprises a multiplier matrix;
obtain, for processing on the reconfigurable fabric, a second matrix, wherein the second matrix comprises a multiplicand matrix;
partition the first matrix and the second matrix, respectively, into a first set of submatrices and a second set of submatrices;
distribute the first set of submatrices around a subset of the plurality of processing elements, wherein the subset of the plurality of processing elements comprises a sequential path of adjacent processing elements within the reconfigurable fabric, wherein the sequential path forms a closed loop of processing elements starting and ending with a same first processing element;
distribute the second set of submatrices around the subset of the plurality of processing elements;
perform a partial matrix multiplication at each of the subset of the plurality of processing elements that comprise a sequential path, wherein a portion of the second set of submatrices is sequentially rotated through the subset of the plurality of processing elements; and
output a result by recomposing results of the partial matrix multiplication at the subset of the plurality of processing elements that comprise the sequential path into a product matrix.
